(19) United States
(12) Patent Application Publication
(10) Pub. No.: US 2024/0403755 A1
(43) Pub. Date: Dec. 5, 2024

(54) PLANNING SYSTEM, PLANNING METHOD, AND PLANNING PROGRAM

(71) Applicants: KABUSHIKI KAISHA TOSHIBA, Tokyo (JP); Toshiba Electronic Devices & Storage Corporation, Tokyo (JP)

(72) Inventor: Katsumi Narimatsu, Yokohama Kanagawa (JP)

(73) Assignees: KABUSHIKI KAISHA TOSHIBA, Tokyo (JP); Toshiba Electronic Devices & Storage Corporation, Tokyo (JP)

(21) Appl. No.: 18/435,284

(22) Filed: Feb. 7, 2024

(30) Foreign Application Priority Data
May 31, 2023 (JP) 2023-090165

(51) Int. Cl. G06Q 10/0631

(52) U.S. Cl. CPC G06Q 10/06313

(57) ABSTRACT

According to one embodiment, a planning system includes an allocating unit configured to perform an allocation process of allocating, for each of production operations of producing products planned to be conducted on multiple planned production dates, at least one of multiple allocation materials which comprise one or more parts and one or more work-in-progress items, wherein, in the allocation process, the allocating unit calculates, for each of the production operations of producing the products for which the one or more parts are allocated, an expected consumption date representing a schedule to consume the allocated one or more parts.

### CROSS-REFERENCE TO RELATED APPLICATION(S)

This application is based upon and claims the benefit of priority from Japanese Patent Application No. 2023-090165, filed May 31, 2023, the entire contents of which are incorporated herein by reference.

### FIELD

Embodiments described herein relate generally to a planning system, a planning method, and a planning program.

### BACKGROUND

A planning system for generating a plan for product production is known. Such a planning system, for example, determines a product delivery time for replies to customers based on the generated plan.

### BRIEF DESCRIPTION OF THE DRAWINGS

FIG. 1 is a block diagram showing an exemplary hardware configuration of the planning system according to an embodiment.

FIG. 2 is a block diagram showing an exemplary functional configuration of the planning system according to an embodiment.

FIG. 3 is a schematic diagram showing an example of production lines for the products for which a plan is prepared through use of the planning system according to an embodiment.

FIG. 4 is a table for explaining an example of product-by-WIP item allocation master information included in basic information for use in the planning system according to an embodiment.

FIG. 5 is a table for explaining an example of product-by-part request master information included in the basic information for use in the planning system according to an embodiment.

FIG. 6 is a table for explaining an example of production capacity information included in the basic information for use in the planning system according to an embodiment.

FIG. 7 is a table for explaining an example of part inventory/reply information for use in the planning system according to an embodiment.

FIG. 8 is a table for explaining an example of WIP item information for use in the planning system according to an embodiment.

FIG. 9 is a table for explaining an example of finished product stock information for use in the planning system according to an embodiment.

FIG. 10 is a table for explaining an example of production result information for use in the planning system according to an embodiment.

FIG. 11 is a table for explaining an example of production plan guide information for use in the planning system according to an embodiment.

FIG. 12 is a table for explaining an example of demand information for use in the planning system according to an embodiment.

FIG. 13 is a table for explaining an example of production plan information generated by the planning system according to an embodiment.

FIG. 14 is a table for explaining an example of allocation information generated by the planning system according to an embodiment.

FIG. 15 is a table for explaining an example of production plan/reply plan information generated by the planning system according to an embodiment.

FIG. 16 is a table for explaining an example of customer-directed reply information generated by the planning system according to an embodiment.

FIG. 17 is a table for explaining an example of part request information generated by the planning system according to an embodiment.

FIG. 18 is a table for explaining an example of monthly summary information generated by the planning system according to an embodiment.

FIG. 19 is a flowchart for explaining an exemplary planning operation conducted with the planning system according to an embodiment.

FIG. 20 is a flowchart for explaining an exemplary generation of allocation information conducted with the planning system according to an embodiment.

FIG. 21 is a flowchart for explaining an exemplary allocation of materials conducted with the planning system according to an embodiment.

FIG. 22 is a flowchart for explaining another exemplary allocation of materials conducted with the planning system according to an embodiment.

FIG. 23 shows allocation information per product for the generation of production plan/reply plan information.

FIG. 24 is a flowchart for explaining an exemplary generation of customer-directed reply information conducted with the planning system according to an embodiment.

FIG. 25 shows an example of summary information per demand status generated by a monthly summary preparing unit.

FIG. 26 is a flowchart for explaining an exemplary generation of monthly summary information conducted with the planning system according to an embodiment.

### DETAILED DESCRIPTION

In general, according to one embodiment, a planning system includes an allocating unit configured to perform an allocation process of allocating, for each of production operations of producing products planned to be conducted on multiple planned production dates, at least one of multiple allocation materials which comprise one or more parts and one or more work-in-progress items, wherein, in the allocation process, the allocating unit calculates, for each of the production operations of producing the products for which the one or more parts are allocated, an expected consumption date representing a schedule to consume the allocated one or more parts.

Embodiments will be described with reference to the drawings. The description will use the same reference symbols for the structural features or components having equivalent or substantially equivalent functions and configurations.

### 1 Embodiments

A planning system according to one or more embodiments will be described.

### 1.1 Configurations

Configurations of the planning system according to one or more embodiments will be described.

### 1.1.1 Hardware Configuration

A hardware configuration of the planning system according to one or more embodiments will be described.

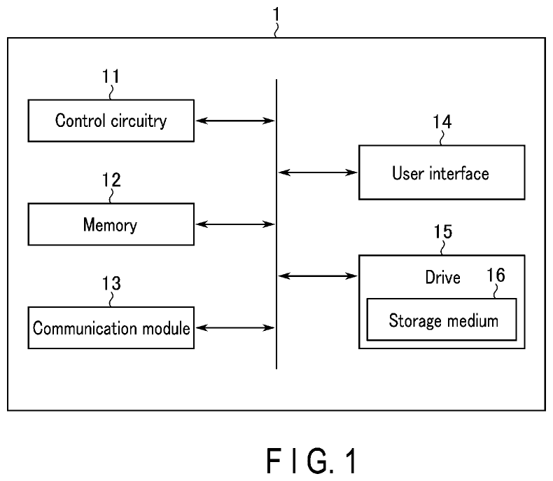

FIG. 1 is a block diagram showing an exemplary hardware configuration of the planning system according to an embodiment. As shown in FIG. 1, the planning system, denoted by “1”, includes control circuitry 11, a memory 12, a communication module 13, a user interface 14, and a drive 15. The drive 15 may include a storage medium 16.

The control circuitry 11 is a circuitry member which assumes total control over each component of the planning system 1. The control circuitry 11 includes a central processing unit (CPU), a random access memory (RAM), a read only memory (ROM), etc.

The memory 12 is an auxiliary storage device for the planning system 1. Examples of the memory 12 include a hard disk drive (HDD), a solid state drive (SSD), a memory card, and so on. The memory 12 stores various information sets and one or more planning programs for use in planning operations conducted by the planning system 1.

In a planning operation, the planning system 1 generates a production plan intended for the production of subject products. Also in a planning operation, the planning system 1 performs allocation of parts and work-in-progress items (WIP items) for the product production based on a generated production plan. In a planning operation, further, the planning system 1 generates, based on an allocation result, part request information for providing a supplier with an order for parts, and customer-directed reply information which contains a product delivery time and which is to be conveyed to a customer. The planning operations will be described in more detail later.

The communication module 13 is a circuitry member for use in transmission and reception of data via a network.

The user interface 14 is a circuitry member for enabling communication of information between a user and the control circuitry 11. The user interface 14 may be furnished with one or more input devices and one or more output devices. Examples of the input devices include a touch panel, operation buttons, and so on. Examples of the output devices include a liquid crystal display (LCD), an electroluminescence (EL) display, a printer, and so on. The user interface 14 converts an input received from a user (a user input) into an electrical signal and transmits it to the control circuitry 11. The user interface 14 may receive an outcome of planning program execution from the control circuitry 11 and output this outcome to the user.

The drive 15 is a device for reading a program or programs stored in the storage medium 16. The drive 15 may include, for example, one or more of a compact disk (CD) drive, a digital versatile disk (DVD) drive, etc.

The storage medium 16 is a medium which stores information sets, such as a program, through electrical, magnetic, optical, mechanical, and/or chemical actions. The storage medium 16 may store one or more planning programs.

### 1.1.2 Functional Configuration

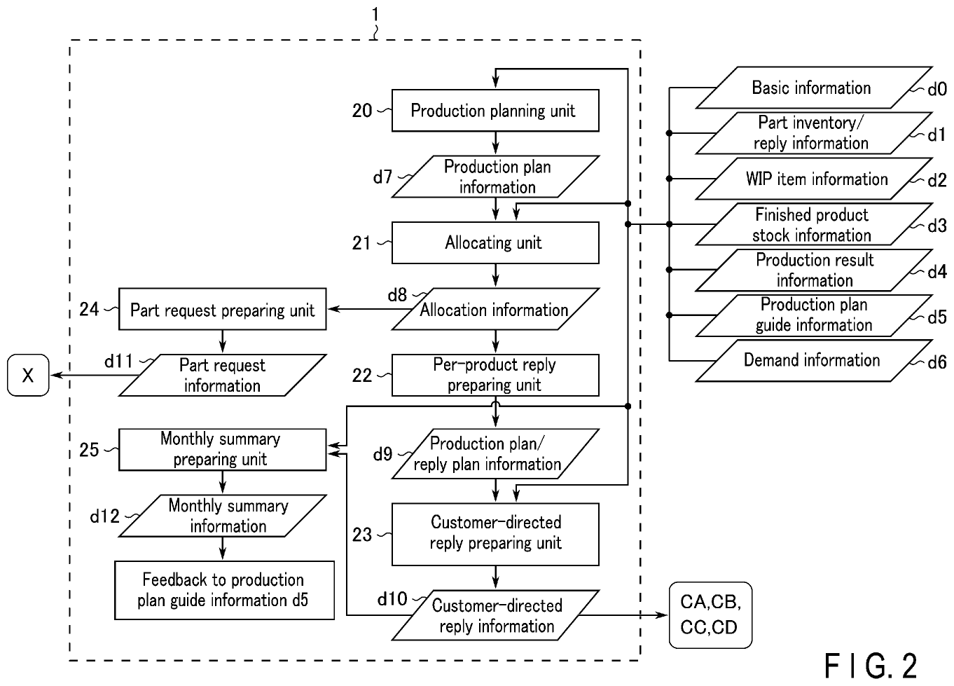

Next, a functional configuration of the planning system according to one or more embodiments will be described with reference to FIG. 2. FIG. 2 is a block diagram showing an exemplary functional configuration of the planning system according to an embodiment. Note that, in addition to the functional configuration, FIG. 2 also indicates information handled by each feature in the functional configuration.

In one example, the CPU in the control circuitry 11 loads the planning program stored in the memory 12 or the storage medium 16 into the RAM. The CPU in the control circuitry 11 then executes the planning program loaded into the RAM so as to control the memory 12, the communication module 13, the user interface 14, the drive 15, and the storage medium 16. The planning system 1 thus functions as a computer including a production planning unit 20, an allocating unit 21, a per-product reply preparing unit 22, a customer-directed reply preparing unit 23, a part request preparing unit 24, and a monthly summary preparing unit 25.

In one example, the planning system 1 receives inputs of basic information d0, part inventory/reply information d1, WIP item information d2, finished product stock information d3, production result information d4, production plan guide information d5, and demand information d6. In the description below, each of the basic information d0, part inventory/reply information d1, WIP item information d2, finished product stock information d3, production result information d4, production plan guide information d5, and demand information d6 will be referred to simply as “input information” if the context does not require a distinction among the basic information d0, the part inventory/reply information d1, the WIP item information d2, the finished product stock information d3, the production result information d4, the production plan guide information d5, and the demand information d6. The planning system 1 performs its planning operations using input information d0 to d6. Such input information d0 to d6 may be input by, for example, a user via the user interface 14. Input information d0 to d6 may be stored in, for example, the memory 12 or the storage medium 16. Note that the stored input information d0 to d6 may also be updated by, for example, the user via the user interface 14.

The basic information d0 may be constituted by various information sets, and examples of such information sets include information used for allocating each work-in-progress item and each part so that they will be adopted in the intended product production, and information on the production capacity for each product.

The part inventory/reply information d1 includes, for example, information on the arrival states of parts.

The WIP item information d2 includes, for example, information on work-in-progress items available on the day the planning operation is carried out (a “planning date”).

The finished product stock information d3 includes, for example, information on the stocks of each product.

The production result information d4 includes, for example, information on the quantity of each product produced.

The production plan guide information d5 includes, for example, information on a planned per-month quantity of each product. A planned per-month quantity refers to a target quantity value of each product to be produced in a given month.

The demand information d6 includes, for example, information on each demand. The information on a demand may reflect a receipt, or expectation of a receipt, of a product order from a customer.

The input information d0 to d6 will be described in more detail later.

The production planning unit 20, in one example, prepares a production plan for each product using all or one or more of the input information d0 to d6. It may be construed that a production plan is a plan for achieving the production of a planned per-month quantity of each product. A production plan indicates, for example, one or more planned production dates for the production of a product to take place, and a target quantity value of the product to be produced on each planned production date, namely, a planned per-day quantity. The production planning unit 20 prepares a production plan so that, for each product, the sum of planned per-day quantities corresponding to the planned production dates within a month equals the planned per-month quantity of the month. The production planning unit 20 also generates production plan information d7 containing such a production plan. The production plan information d7 will be described in more detail later.

The allocating unit 21, in one example, allocates parts and work-in-progress items for each combination of a product and a planned production date indicated in the production plan information d7, using all or one or more of the input information d0 to d6. The allocating unit 21 generates allocation information indicating allocated parts and work-in-progress items. The allocation information d8 will be described in more detail later.

The per-product reply preparing unit 22, in one example, prepares a reply plan based on the allocation information d8. A reply plan here refers to, for example, a plan estimating a producibility of each product based on the result of allocating parts and work-in-progress items. It may be construed that the reply plan is a practical plan which takes into account the statuses of parts and work-in-progress items. A reply plan indicates one or more for-reply planned dates associated with a combination of a product and a planned production date, and also indicates a planned partial quantity or quantities. Here, the for-reply planned date or dates constitute a schedule which practically allows for the product production originally planned with the planned production date. The planned partial quantity or quantities each refer to the quantity of product that can be produced on the respective for-reply planned date. In one example, the per-product reply preparing unit 22 prepares a reply plan so that the sum of planned partial quantities associated with a combination of a product and a planned production date equals the planned per-day quantity of the product on this planned production date. In one example, the per-product reply preparing unit 22 also generates production plan/reply plan information d9 containing such a reply plan. The production plan/reply plan information d9 will be described in more detail later.

The customer-directed reply preparing unit 23, in one example, allocates stocked products and not-yet-stocked products (i.e., products planned to be produced) for respective demands indicated in the demand information d6, using all or one or more of the input information d0 to d6 and the production plan/reply plan information d9. Also in one example, the customer-directed reply preparing unit 23 prepares a product delivery time to be provided to a customer (a “customer-directed reply”) for each demand. The customer-directed reply preparing unit 23 generates customer-directed reply information d10 containing information on the product allocation for each demand and such a customer-directed reply. The customer-directed reply information d10 will be described in more detail later.

In one example, the customer-directed reply information d10 is sent to a customer or customers. Note that, as the customers to be handled, the description will assume customers CA, CB, CC, and CD. However, this does not limit the number of customers, and any number of customers may be involved as long as that number is one or more. Also, in the description below, the customers CA, CB, CC, and CD will each simply be called a “customer C” if the context does not require a distinction among the customers CA, CB, CC, and CD.

The part request preparing unit 24, in one example, extracts information on parts allocated for product production from the allocation information d8. Also in one example, the part request preparing unit 24 generates part request information d11 based on the extracted information. The part request information d11 will be described in more detail later.

In one example, the part request information d11 is sent to a supplier or suppliers who supply parts. For the sake of simplicity in explanation, the description will assume instances with a supplier X. However, this does not limit the number of suppliers, and any number of suppliers may be involved.

The monthly summary preparing unit 25, in one example, generates monthly summary information d12 on the demands, sales, and inventories in each month using all or one or more of the input information d0 to d6 and the customer-directed reply information d10. The monthly summary information d12 will be described in more detail later.

The monthly summary information d12 may serve as, for example, a feedback for the production plan guide information d5 used for the next and subsequent planning operations. In other words, the planned per-month quantity of each product may be set and corrected based on the monthly summary information d12. The production plan guide information d5 after the feedback is used for the generation of new production plan information d7 by the production planning unit 20.

Note that each of the input information d0 to d6, the production plan information d7, the allocation information d8, the production plan/reply plan information d9, the customer-directed reply information d10, the part request information d11, and the monthly summary information d12 may be retained in the memory 12 or the storage medium 16.

### 1.2 Products

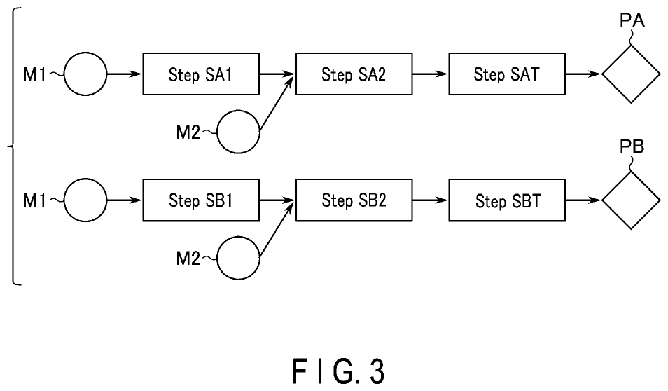

A description will be given of an example of production lines for products which are the subjects of planning operations performed by the planning system 1 according to one or more embodiments, with reference to FIG. 3. FIG. 3 is a schematic diagram showing one example of production lines for the products for which a plan is prepared using the planning system 1 according to an embodiment. The description will assume an instance where the planning system 1 performs the planning operation for types of products PA and PB. However, the description here intends no limitation, and the planning operation may be performed for only one product type, or three or more product types.

The product PA is produced from parts M1 and M2 through a production line including steps SA1, SA2, and SAT. More specifically, the part M1 is introduced at the step SA1. The process of the step SA1 is conducted on the introduced part M1. The part M2 is then introduced at the step SA2. The process of the step SA2 is conducted using the introduced part M2 and the part M1 that has undergone the process of the step SA1. The process of the step SAT is conducted at the end. The step SAT is, for example, a quality inspection of the product PA. The product PA is thus produced.

The product PB is produced from parts M1 and M2, the same as those for the product PA, through a production line including steps SB1, SB2, and SBT. The production line for the product PB is the same as the production line for the product PA except that the steps SB1, SB2, and SBT are performed instead of the steps SA1, SA2, and SAT; the redundant explanation will hence be omitted.

In the description below, the products PA and PB will each simply be called a “product P” if the context does not require a distinction between the products PA and PB. Also in the description below, the parts M1 and M2 will each simply be called a “part M” if the context does not require a distinction between the parts M1 and M2. In the description below, further, the steps SA1, SA2, SAT, SB1, SB2, and SBT will each simply be called a “step S” if the context does not require a distinction among the steps SA1, SA2, SAT, SB1, SB2, and SBT.

### 1.3 Input Information

The input information d0 to d6 to the planning system 1 according to one or more embodiments will be described in detail.

### Basic Information d0

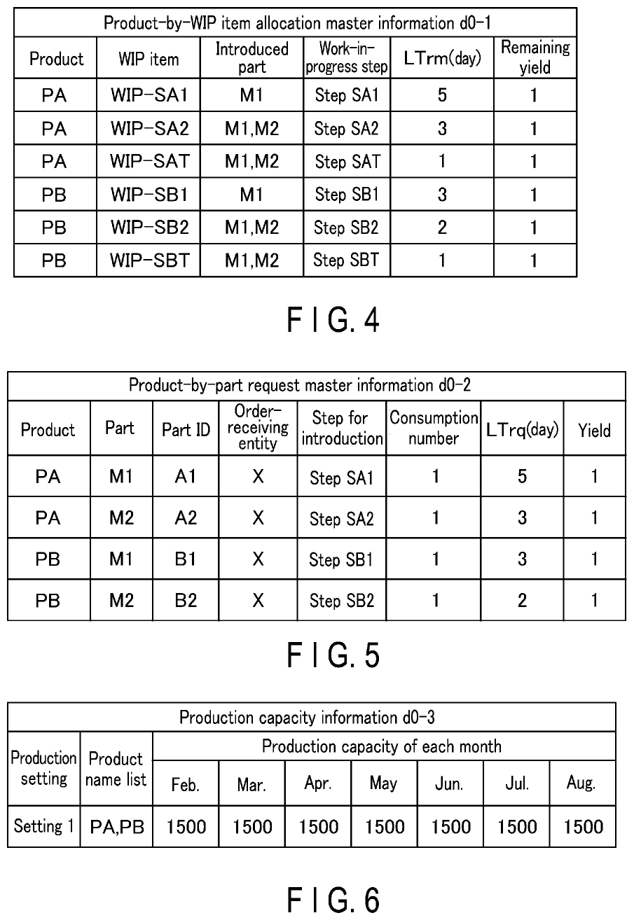

In one example, the basic information d0 includes product-by-WIP item allocation master information d0-1, product-by-part request master information d0-2, and production capacity information d0-3. The basic information do will be explained with reference to FIGS. 4, 5, and 6. FIG. 4 is a table for explaining an example of product-by-WIP item allocation master information d0-1 included in the basic information d0 for use in the planning system 1 according to an embodiment. FIG. 5 is a table for explaining an example of product-by-part request master information d0-2 included in the basic information d0 for use in the planning system 1 according to an embodiment. FIG. 6 is a table for explaining an example of production capacity information d0-3 included in the basic information do for use in the planning system 1 according to an embodiment.

In the description below, a set of data contained in one row of each table may also be called a “record”.

The product-by-WIP item allocation master information d0-1 is used for the allocation of each work-in-progress item for use in the production of products P. As shown in FIG. 4, the product-by-WIP item allocation master information d0-1 contains, for example, information on products P, work-in-progress items, introduced parts, work-in-progress steps, remaining lead times LTrm, and remaining yields. In this product-by-WIP item allocation master information d0-1, an introduced part or parts, a work-in-progress step, a remaining lead time LTrm, and a remaining yield are retained for each work-in-progress item.

The work-in-progress items here include work-in-progress items WIP-SA1, WIP-SA2, WIP-SAT, WIP-SB1, WIP-SB2, and WIP-SBT. The work-in-progress items WIP-SA1, WIP-SA2, and WIP-SAT are work-in-progress items for products PA. The work-in-progress items WIP-SB1, WIP-SB2, and WIP-SBT are work-in-progress items for products PB. The work-in-progress items WIP-SA1, WIP-SA2, WIP-SAT, WIP-SB1, WIP-SB2, and WIP-SBT are work-in-progress items currently undergoing the processes of the steps SA1, SA2, SAT, SB1, SB2, and SBT, respectively. In the description below, the work-in-progress items WIP-SA1, WIP-SA2, WIP-SAT, WIP-SB1, WIP-SB2, and WIP-SBT will each simply be called a “work-in-progress item WIP” if the context does not require a distinction among the work-in-progress items WIP-SA1, WIP-SA2, WIP-SAT, WIP-SB1, WIP-SB2, and WIP-SBT.

The work-in-progress steps are steps S which are being carried out on the respective work-in-progress items WIP. That is, the work-in-progress steps on the work-in-progress items WIP-SA1, WIP-SA2, WIP-SAT, WIP-SB1, WIP-SB2, and WIP-SBT are the respective steps SA1, SA2, SAT, SB1, SB2, and SBT.

The introduced parts for each work-in-progress item WIP are parts M introduced into the corresponding production line in or before the respective work-in-progress steps for the work-in-progress item. More specifically, the part M1 is an introduced part for each of the work-in-progress items WIP-SA1 and WIP-SB1. Also, the parts M1 and M2 are introduced parts for each of the work-in-progress items WIP-SA2, WIP-SAT, WIP-SB2, and WIP-SBT.

The remaining lead time LTrm for each work-in-progress item WIP refers to the number of days from the start of the work-in-progress step for the work-in-progress item up to the completion of the product production.

The remaining yield for each work-in-progress item WIP is a value of the ratio obtained by multiplying the yields in steps S subsequent to the subject work-in-progress step for the work-in-progress item. Note that, for the sake of simplicity of explanation, the description of this example of the embodiment will assume the remaining yield for each work-in-progress item to be 1.

As described above, an introduced part or parts, a work-in-progress step, a remaining lead time LTrm, and a remaining yield are retained for each work-in-progress item, and the allocation of work-in-progress items WIP for the respective products P is therefore facilitated.

The product-by-part request master information d0-2 is used for the allocation of each part M for use in the production of products P. As shown in FIG. 5, the product-by-part request master information d0-2 contains, for example, information on products P, parts M, part identifiers (part IDs), suppliers (or order-receiving entities), steps for introduction, consumption numbers, required lead times LTrq, and yields. In this product-by-part request master information d0-2, a part identifier (part ID), a supplier (order-receiving entity), a step for introduction, the consumption number, a required lead time LTrq, and a yield are retained in association with each combination of a product P and a part M.

The part identifier refers to, in one example, an identifier to indicate a step S into which a part M is introduced (i.e., a step for introduction). The part identifiers include part identifiers A1, A2, B1, and B2. The part identifiers A1, A2, B1, and B2 are indicative of their corresponding parts M being introduced at the steps SA1, SA2, SB1, and SB2, respectively.

The consumption number refers to, in one example, the quantity of parts M used for producing one product P.

The required lead time LTrq is, in one example, the number of days from the introduction of a part M up to the completion of the production of a product P. More specifically, and for example, the required lead times LTrq for parts M1 and M2 intended for a product PA are the same as the respective remaining lead times LTrm for the work-in-progress items WIP-SA1 and WIP-SA2. Also, the required lead times LTrq for parts M1 and M2 intended for a product PB are the same as the respective remaining lead times LTrm for the work-in-progress items WIP-SB1 and WIP-SB2.

The yields are, in one example, yields of the respective parts M for the production of products P.

For the sake of simplicity of explanation, the description will assume instances where the supplier X supplies all of the parts M intended for the products PA and PB.

The production capacity information d0-3 includes information on the production capacity for the products PA and PB. As shown in FIG. 6, the production capacity information d0-3 contains information on the setting for production, a list of product names, and the production capacity for each month.

The setting for production is, in one example, a setting selected in advance for determining the production capacity for each month. The description will assume, by way of example, the production setting to be setting 1. This setting 1, for example, sets the production capacity for each month to a predetermined fixed value. Note that, while not shown in the figure, the production setting may be different from the setting 1. The production capacities for the months here may be set to values differing from each other. The description will assume, unless otherwise specified, that months and days are the months and the days within the same year.

The list of product names is a list of products P to be produced.

The production capacity for each month may be a total output or quantity of the products P indicated in the list of product names for which production in the month is possible.

### Part Inventory/Reply Information d1

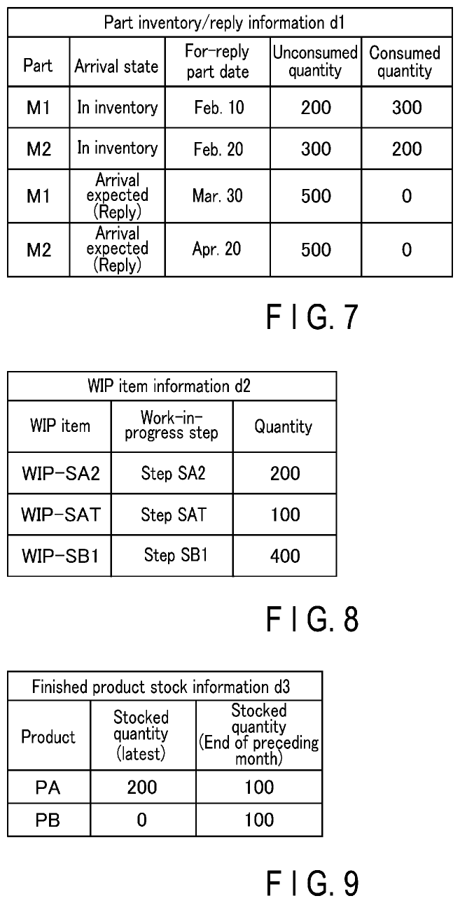

The part inventory/reply information d1 will be explained with reference to FIG. 7. FIG. 7 is a table for explaining an example of the part inventory/reply information d1 for use in the planning system 1 according to an embodiment.

The part inventory/reply information d1 contains, for example, information on parts M, arrival states, for-reply part dates, unconsumed quantities, and consumed quantities. In this part inventory/reply information d1, for example, an unconsumed quantity and a consumed quantity are retained in association with each combination of a part M, an arrival state, and a for-reply part date.

The arrival state here includes, for example, “In inventory” which indicates that the corresponding parts M have already arrived, and “Arrival expected” which indicates that the parts M will be available later. In the description below, the arrival state showing “Arrival expected” may also be called an arrival state showing “Reply”.

The for-reply part dates refer to, for example, the arrival dates of parts M. More specifically, each for-reply part date refers to the date on which a part M with an arrival state showing “In inventory” has arrived, or the date for which the arrival of a part M with an arrival state showing “Reply” is scheduled.

The unconsumed quantities each refer to, for example, an unused quantity of the corresponding parts M among the quantity (incoming quantity) of the parts M that have arrived on the for-reply part date. It will be assumed that the unconsumed quantity of parts M with an arrival state showing “Reply” equals the incoming quantity of these parts M.

The consumed quantities each refer to, for example, an already used quantity of the corresponding parts M among the incoming quantity of the parts M. A part M having been already used means, for example, that the introduction of this part M into a step S has already been conducted. Note that the consumed quantity of parts M with an arrival state showing “Reply” is 0.

### WIP Item Information d2

The WIP item information d2 will be explained with reference to FIG. 8. FIG. 8 is a table for explaining an example of the WIP item information d2 for use in the planning system 1 according to an embodiment. FIG. 8 assumes an instance where work-in-progress items WIP-SA2, WIP-SAT, and WIP-SB2 are available at the time of performing a planning operation.

In one example, the WIP item information d2 contains information on work-in-progress items WIP, work-in-progress steps, and quantities of the work-in-progress items WIP. In the WIP item information d2, for example, a work-in-progress step and a quantity are retained in association with the corresponding available work-in-progress item WIP. The quantities here refer to the quantities of the respective work-in-progress items WIP available on the planning date.

### Finished Product Stock Information d3

The finished product stock information d3 will be explained with reference to FIG. 9. FIG. 9 is a table for explaining an example of the finished product stock information d3 for use in the planning system 1 according to an embodiment.

In one example, the finished product stock information d3 contains information on products P, the latest stocked quantities, and the stocked quantities as of the end of a month which precedes the month including the planning date (i.e., a “planning month”). In FIG. 9, the latest stocked quantities and the stocked quantities as of the end of the preceding month are given under “Stocked quantity (latest)” and “Stocked quantity (end of last month)”, respectively. In the finished product stock information d3, for example, a latest stocked quantity and a stocked quantity as of the end of the preceding month are retained in association with the corresponding product P.

The latest stocked quantities here refer to the quantities of the respective products P stocked as of the planning date.

The stocked quantities as of the end of the preceding month refer to the quantities of the respective products P stocked as of the end of the month preceding the planning month.

### Production Result Information d4

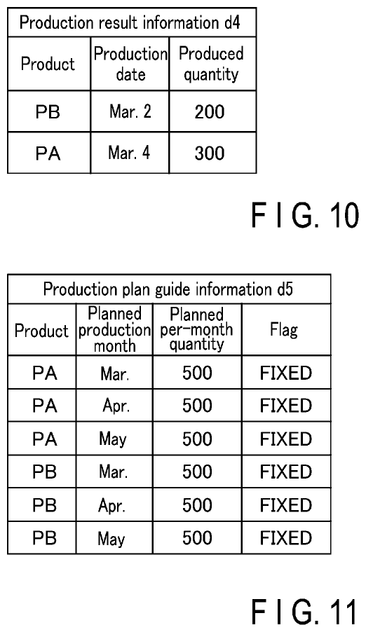

The production result information d4 will be explained with reference to FIG. 10. FIG. 10 is a table for explaining an example of the production result information d4 for use in the planning system 1 according to an embodiment.

The production result information d4 contains, in one example, information on products P, production dates, and produced quantities. In this production result information d4, for example, a produced quantity is retained in association with each combination of a product P and a production date.

The production dates here refer to, for example, the dates on which the respective products P were produced. The produced quantities refer to the quantities

of the respective products P produced on the corresponding production dates.

### Production Plan Guide Information d5

The production plan guide information d5 will be explained with reference to FIG. 11. FIG. 11 is a table for explaining an example of the production plan guide information d5 for use in the planning system 1 according to an embodiment.

The production plan guide information d5 contains, in one example, information on products P, planned production months, planned per-month quantity, and flags. In this production plan guide information d5, for example, a planned per-month quantity and a flag are retained in association with each combination of a product P and a planned production month.

The planned production month here refers to, for example, a month scheduled for the production of the corresponding product P. FIG. 11 assumes an instance where March, April, and May are included as the planned production months for the products P.

The planned per-month quantity refers to the quantity of the corresponding product P to be produced in the associated planned production month.

The flag indicates, for example, whether or not the planned per-month quantity associated with it should be a predetermined fixed value. With the flag showing, for example, “FIXED”, the planned per-month quantity is set to the predetermined fixed value. In the example shown in FIG. 11, it is assumed that all the planned production months for the products PA and PB are associated with the flags showing “FIXED”. Note that, although not shown in the figure, the planned per-month quantities may, for example, take on values different from the fixed value if the associated flags are not “FIXED”.

### Demand Information d6

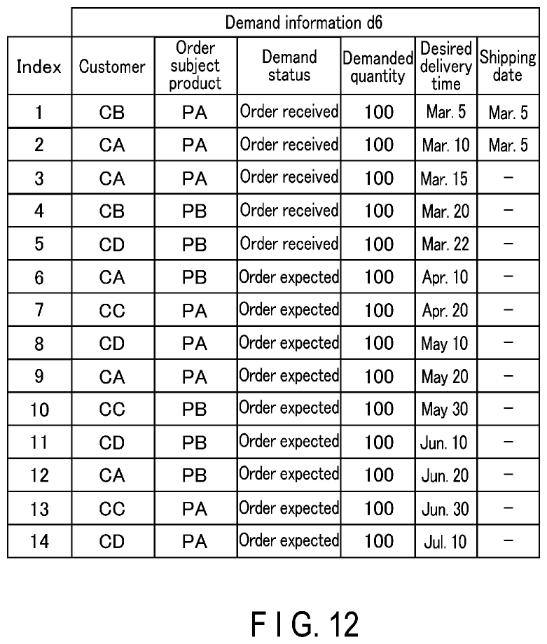

The demand information d6 will be explained with reference to FIG. 12. FIG. 12 is a table for explaining an example of the demand information d6 for use in the planning system 1 according to an embodiment. Note that, for the sake of explanation, the table in the figure includes indexes added to the respective records in a regular order.

The demand information d6 contains, in one example, information on customers C, order subject products, demand statuses, demanded quantities, desired delivery times, and shipping dates. In the demand information d6, for example, each combination of a customer C, an order subject product, a demand status, a demanded quantity, a desired delivery time, and a shipping date is retained. Each record in the demand information d6 may simply be called a “demand”.

The order subject product here refers to a product P for which an order from the customer C has already been received, or a product P for which an order from the customer C is expected.

The demand status indicates an order situation for the order subject product. The demand status includes, for example, “Order received” and “Order expected”. In the instance where the order subject products are products P for which orders have already been received, the demand statuses are shown as “Order received”. In the instance where the order subject products are products P for which orders are expected, the demand statuses are shown as “Order expected”.

The demanded quantity refers to the quantity of the order subject product in each record in the demand information d6. In the instance where the order subject product is a product P for which an order has already been received, the demanded quantity is a quantity ordered by the customer C. In the instance where the order subject product is a product P for which an order is expected, the demanded quantity is a quantity expected to be ordered by the customer C.

The desired delivery times refer to intended delivery times for the respective order subject products. In the instance where the order subject product is a product P for which an order has already been received, the desired delivery time indicates a delivery time requested by the customer C for this order subject product. In the instance where the order subject product is a product P for which an order is expected, the desired delivery time indicates a delivery time expected to be requested by the customer C for this order subject product.

The shipping date refers to the date of shipment of the order subject product in each record in the demand information d6. In the example shown in FIG. 12, the shipping dates in the records for not-yet-shipped order subject products are shown as “—”.

In the demand information d6 as shown in, for example, FIG. 12 explained above, the first record indicates that an order for 100 products PA was received from a customer CB, that the delivery time requested by the customer CB is March 5, and that these products PA have been shipped out on March 5. Also in FIG. 12, for example, the sixth record indicates that an order for 100 products PB is expected to be received from a customer CA, that the delivery time expected to be requested by the customer CA is April 10, and that these products PB are yet to be shipped out.

### 1.4 Information Generated by Planning System

A description will be given of information generated by the planning system 1, namely, production plan information d7, allocation information d8, production plan/reply plan information d9, customer-directed reply information d10, part request information d11, and monthly summary information d12.

### Production Plan Information d7

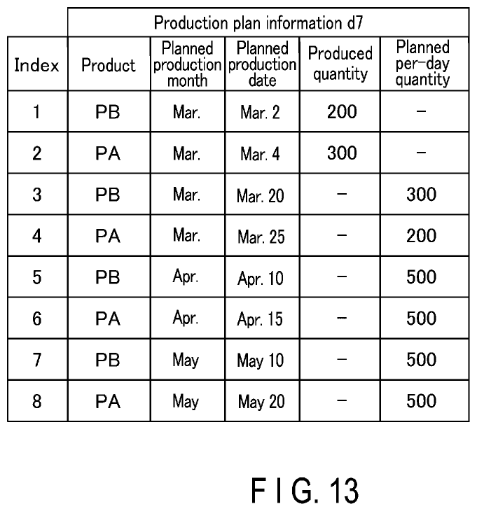

The production plan information d7 will be explained with reference to FIG. 13. FIG. 13 is a table for explaining an example of the production plan information d7 generated by the planning system 1 according to an embodiment.

The production plan information d7 contains, in one example, information on products P, planned production months, planned production dates, produced quantities, and planned per-day quantities. In this production plan information d7, for example, a produced quantity and a planned per-day quantity are retained in association with each combination of a product P, a planned production month, and a planned production date.

In the example shown in FIG. 13, the produced quantities in the records for not-yet produced products P are shown as “—”. The planned per-day quantities in the records for already-produced products P are shown as “—”.

In the production plan information d7 as shown in, for example, FIG. 13 explained above, the third record indicates that the planned production month and the planned production date for the product PB are March and March 20, respectively, that the production of the product PB on the planned production date is yet to be carried out, and that the planned per-day quantity for the planned production date is 300.

As such, the production plan information d7 covers a production plan including a planned production date and a planned per-day quantity.

### Allocation Information d8

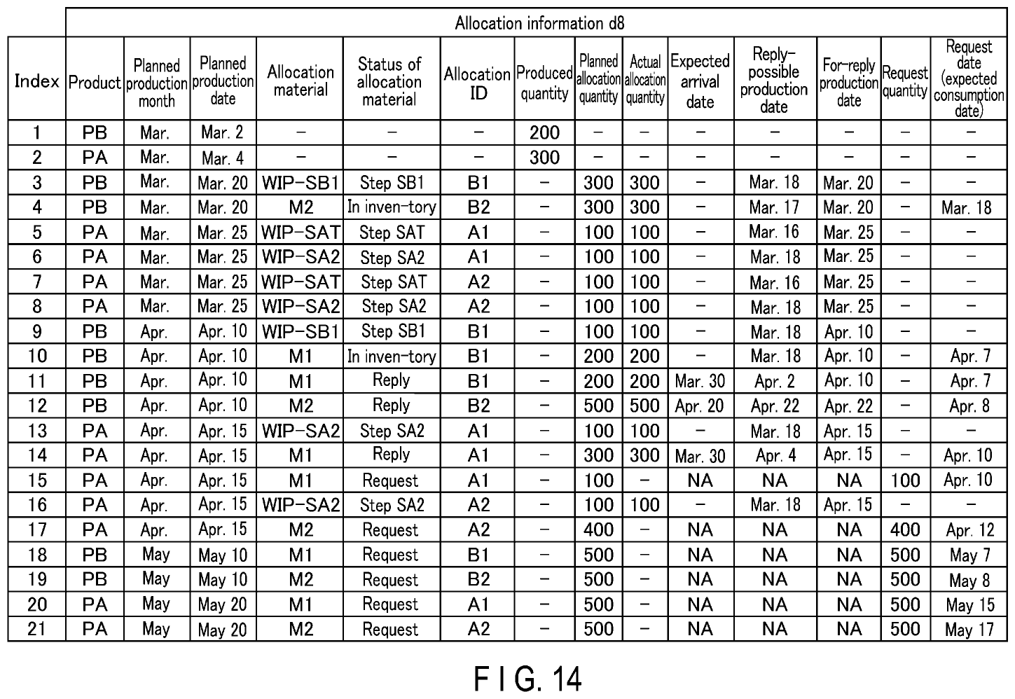

The allocation information d8 will be explained with reference to FIG. 14. FIG. 14 is a table for explaining an example of the allocation information d8 generated by the planning system 1 according to an embodiment.

The allocation information d8 contains, in one example, information on products P, planned production months, planned production dates, allocation materials, statuses of the allocation materials, allocation identifiers (allocation IDs), produced quantities, planned allocation quantities, actual allocation quantities, expected arrival dates, reply-possible production dates, for-reply production dates, request quantities, and request dates (expected consumption dates). In this allocation information d8, for example, a produced quantity, a planned allocation quantity, an expected arrival date, a reply-possible production date, a for-reply production date, a request quantity, and a request date are retained in association with each combination of a product P, a planned production month, a planned production date, an allocation material, a status of the allocation material, and an allocation identifier.

The allocation materials are materials including a part M and a work-in-progress item WIP allocated for the production of the product P. For the product P related to each planned production date, one or more allocation materials are allocated. Note that, since no allocation materials are allocated for already-produced products P, the allocation materials in the records for such already-produced products are shown as “—” in FIG. 14.

The status of an allocation material is a status indicating an inventory state, a work-in-progress step, etc. for the allocation material. In instances where the allocation material is a part M, the status of the allocation material shows one selected from the arrival states (“In inventory” and “Reply”) of the part based on the part inventory/reply information d1 and the state in which an order for the part is to be given (“Request”). In instances where the allocation material is a work-in-progress item WIP, the status of the allocation material shows the work-in-progress step to which the allocation material is subjected. In other words, the status of the allocation material here is one of “Step SA1”, “Step SA2”, “Step SAT”, “Step SB1”, “Step SB2”, and “Step SBT”. Note that, since no allocation materials are allocated for already-produced products P, the statuses of allocation materials in the records for such already-produced products are shown as “—” in FIG. 14.

The allocation identifier is a part identifier corresponding to the allocation material for a product P. More specifically, if the allocation material for a product P is a part M, the allocation identifier is a part identifier of this part. If the allocation material is a work-in-progress item WIP, the allocation identifier is a part identifier of the respective introduced part for this work-in-progress item. That is, in an instance where the allocation material is a work-in-progress item WIP-SA1, the allocation identifier is a part identifier A1. Also, in an instance where the allocation material is a work-in-progress item WIP-SB1, the allocation identifier is a part identifier B1. In each of the case where the allocation material is a work-in-progress item WIP-SA2 and the case where it is a work-in-progress item WIP-SAT (namely, the introduced parts in each case are a set of the parts M1 and M2), the allocation information d8 may retain a record in which the allocation identifier is a part identifier A1 and a record in which the allocation identifier is a part identifier A2. Also, in each of the case where the allocation material is a work-in-progress item WIP-SB2 and the case where it is a work-in-progress item WIP-SBT (namely, the introduced parts in each case are a set of the parts M1 and M2), the allocation information d8 may retain a record in which the allocation identifier is a part identifier B1 and a record in which the allocation identifier is a part identifier B2. Note that, since no allocation materials are allocated for already-produced products P, the allocation identifiers in the records for such already-produced products are shown as “—” in FIG. 14.

The planned allocation quantity refers to the quantity of the allocation material for the production of a product P on the planned production date. Since no allocation materials are allocated for already-produced products P, the planned allocation quantities in the records for such already-produced products are shown as “—” in FIG. 14.

The actual allocation quantity refers to the quantity of the allocation material that is determinable for allocation in the production of a product P on the planned production date. Being determinable for allocation means that the status of the allocation material is not “Request” but one of “In inventory”, “Reply”, “Step SA1”, “Step SA2”, “Step SAT”, “Step SB1”, “Step SB2”, and “Step SBT”. As such, it will be assumed that work-in-progress items WIP, and also parts M for which at least corresponding orders have been made, are determinable for allocation. If the status of an allocation material is shown as “Request”, a part M has not been ordered yet, and therefore, such an allocation material is assumed to be undeterminable for allocation. Note that, in FIG. 14, the actual allocation quantities in the records for allocation materials that are undeterminable for allocation or in the records for already-produced products P are shown as “—”.

The expected arrival date refers to the for-reply part date of the part M which is expected to arrive. That is, the expected arrival dates in the records for allocation materials with the status “Reply” show the respective for-reply part dates based on the part inventory/reply information d1. Meanwhile, in the records for parts M in inventory, or in the records for products P for which work-in-progress items WIP have been allocated, or further in the records for already-produced products P, expected arrival dates are not set. In the example shown in FIG. 14, the expected arrival dates in such records, for which no expected arrival dates are set, are shown as “—”. Note that the expected arrival date for a part M for which an order will be given is not determined yet. In the example shown in FIG. 14, the expected arrival date in such a record, for which an expected arrival date is undeterminable, is shown as “NA”.

The reply-possible production date refers to the earliest date on which the production of an intended product P can be conducted using the allocation material. In one example, the reply-possible production date may be calculated based on the remaining lead time LTrm for a work-in-progress item WIP and the required lead time LTrq for a part M. More specifically, in an instance where the status of an allocation material is “In inventory”, the reply-possible production date conforms to the date which is later than the planning date by the required lead time LTrq for the part M, i.e., the allocation material. In an instance where the status of an allocation material is “Reply”, the reply-possible production date conforms to the date which is later than the expected arrival date by the required lead time LTrq for the part M, i.e., the allocation material. In an instance where the status of an allocation material is “Request”, the reply-possible production date is undeterminable. If an allocation material is a work-in-progress item WIP, the reply-possible production date is the date later than the planning date by the remaining lead time LTrm for this work-in-progress item. Note that the reply-possible production dates in the records for already-produced products P are not set. In the example shown in FIG. 14, the reply-possible production dates in such records, for which no reply-possible production dates are set, are shown as “—”. Also, the reply-possible production dates in the records for allocation materials with the status “Request” are undeterminable. In the example shown in FIG. 14, the reply-possible production dates in such records, for which the reply-possible production dates are undeterminable, are shown as “NA”. By way of illustration, the description will assume that the planning date is March 15.

The for-reply production date is either the planned production date or the reply-possible production date, whichever is later. That is, if the production of a product P on the planned production date is practically impossible because of the reply-possible production date being after the planned production date, the reply-possible production date is set to the for-reply production date as a more feasible production date for the product P. Note that, similar to the above, the for-reply production dates in the records for already-produced products P are not set. In the example shown in FIG. 14, the for-reply production dates in the records without set reply-possible production dates are shown as “—”. Also similar to the above, the for-reply production dates in the records for allocation materials with the status “Request” are undeterminable. As such, in the example shown in FIG. 14, the for-reply production dates in such records, for which the for-reply production dates are undeterminable, are shown as “NA”.

The request quantity refers to the quantity of parts M which will be ordered as allocation materials. Thus, the request quantity equals the planned allocation quantity in the record for an allocation material with the status “Request”. In the example shown in FIG. 14, the request quantities in the records for already-produced products P, and also the request quantities in the records in which the allocation materials are parts M in inventory, parts M expected to arrive, or work-in-progress items WIP, are shown as “—” since there are no parts M to be ordered.

The request date refers to the date on which a part M is used as an allocation material (i.e., the date on which the part M is introduced at step S) so that the production of a product P is conducted on the planned production date. The request date conforms to, for example, the date which is earlier than the planning date by the required lead time LTrq for a part M1 in the basic information d0. Note that the request dates in the records for already-produced products P, or in the records for which allocation materials are work-in-progress items WIP, are not set. In the example shown in FIG. 14, the request dates in such records, for which no request dates are set, are shown as “—”.

In the allocation information d8 as shown in, for example, FIG. 14 explained above, the third record and the fourth record are related to a product PB with the planned production date of March 20. As one example, the third record in FIG. 14 indicates that a work-in-progress item WIP-SB1 is allocated for the production of a product PB for which March 20 is set as the planned production date, that step SB1 is being carried out for the work-in-progress item, that the allocation identifier for the work-in-progress item is an allocation identifier B1, that the product has not yet been produced with the work-in-progress item, that each of the planned allocation quantity and the actual allocation quantity of the work-in-progress item is 300, and that the reply-possible production date and the for-reply production date for the production of the product PB with the work-in-progress item are March 18 and March 20, respectively. The fourth record in FIG. 14 indicates that a part M2 is allocated for a product PB for which March 20 is set as the planned production date, that the arrival state of the part is “In inventory”, that the allocation identifier for the part is an allocation identifier B2, that the product has not yet been produced with the part, that each of the planned allocation quantity and the actual allocation quantity of the part is 300, that the reply-possible production date and the for-reply production date for the production of the product PB with the part are March 17 and March 20, respectively, and that the request date for the part is March 18.

### Production Plan/Reply Plan Information d9

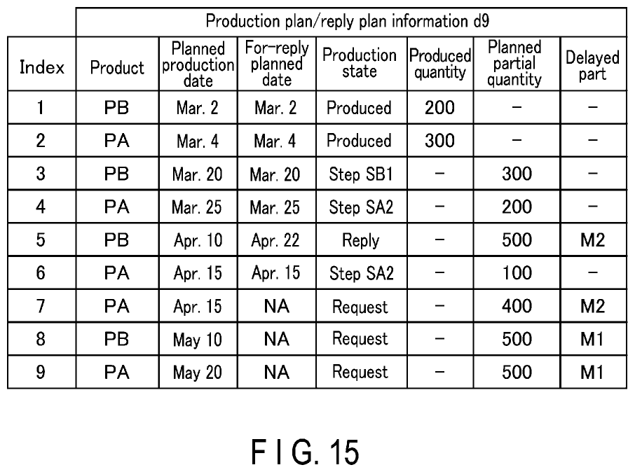

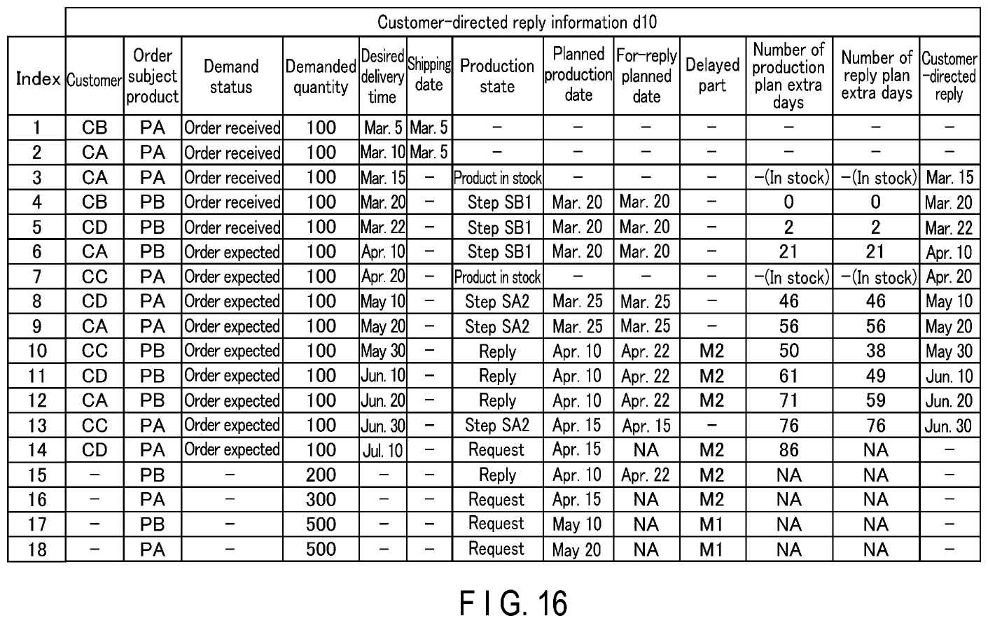

The production plan/reply plan information d9 will be explained with reference to FIG. 15. FIG. 15 is a table for explaining an example of the production plan/reply plan information d9 generated by the planning system 1 according to an embodiment.

The production plan/reply plan information d9 contains, in one example, information on products P, planned production dates, for-reply planned dates, production states, produced quantities, planned partial quantities, and delayed parts. In this production plan/reply plan information d9, for example, a produced quantity, a planned partial quantity, and a delayed part are retained in association with each combination of a product P, a planned production date, a for-reply planned date, and a production state. In the production plan/reply plan information d9, one or more records are retained for each combination of a product P and a planned production date.

The for-reply planned date here is a for-reply production date in a record which is selected from the records included in the allocation information d8 and associated with the respective combinations of a product P and a planned production date. In the production plan/reply plan information d9, in one example, the for-reply planned date in each record associated with the corresponding combination of a product P and a planned production date conforms to the latest for-reply production date among the for-reply production dates in the records included in the allocation information d8 and associated with this combination. If, in the production plan/reply plan information d9, more than one record is associated with the same combination of a product P and a planned production date, the for-reply planned dates of such multiple records differ from one another. The description will assume that the latest schedule (for-reply planned date) is an undetermined schedule (“NA”). The process for selecting the records in the allocation information d8 for the generation of the production plan/reply plan information d9 will be described in more detail later.

The production state refers to the state of a representative allocation material for the production of a product P. In one example, the production state is based on the state of an allocation material included in the record in the allocation information d8, selected as above. The production states include “In inventory”, “Reply”, “Request”, “Step SA1”, “Step SA2”, “Step SAT”, “Step SB1”, “Step SB2”, “Step SBT”, and “Produced”. The production state showing “Produced” means that the production of the intended product P has been complete.

The delayed part refers to a part M which is expected to be delayed in the course of producing a product P on the planned production date using the allocation material included in the record selected as above from the allocation information d8. For example, if the allocation material in the record selected as above from the allocation information d8 is a part M, and if the planned production date is earlier than the request date in this record, the allocation material is handled as the delayed part. Also, if, for example, the planned production date is on or after the request date in the record selected as above from the allocation information d8, it is assumed that no delayed parts are present. In this case, the delayed part is shown as “—” in the example shown in FIG. 15.

In one example, the sum of planned partial quantities in one or more records associated with a combination of a product and a planned production date equals the planned per-day quantity indicated in the record in the production plan information d7 and associated with this planned production date. Note that, since no planned partial quantities are set in the records for already-produced products P, the planned partial quantities in such records are shown as “—” in FIG. 15.

In the production plan/reply plan information d9 as shown in, for example, FIG. 15 explained above, the sixth record and the seventh record are related to a product PA with the planned production date of April 15. As one example, the sixth record in FIG. 15 indicates, for the production of a product PA with the planned production date of April 15, that the production state is “Step SA2”, that the for-reply planned date is April 15, that the planned partial quantity of the product PA in this production state is 100, and that there is no delayed part. Also, the seventh record in FIG. 15 indicates, for the production of a product PA with the planned production date of April 15, that the production state is “Request” (the state where the intended part M is to be ordered), that the for-reply planned date is undetermined, that the planned partial quantity of the product PA in this production state is 400, and that a part M2 is the delayed part.

As such, the production plan/reply plan information d9 covers a reply plan including a for-reply planned date and a planned partial quantity. In the production plan/reply plan information d9, each combination of a for-reply planned date and a planned partial quantity is retained in association with a planned production date, as explained above.

### Customer-Directed Reply Information d10

The customer-directed reply information d10 will be explained with reference to FIG. 16. FIG. 16 is a table for explaining an example of the customer-directed reply information d10 generated by the planning system 1 according to an embodiment.

The customer-directed reply information d10 contains, in one example, information on customers, order subject products, demand statuses, demanded quantities, desired delivery times, shipping dates, production states, planned production dates, for-reply planned dates, delayed parts, the numbers of production plan extra days, the numbers of reply plan extra days, and customer-directed replies. In this customer-directed reply information d10, for example, a shipping date, a production state, a planned production date, a for-reply planned date, a delayed part, the number of production plan extra days, the number of reply plan extra days, and a customer-directed reply are retained in association with each demand.

In the customer-directed reply information d10, for example, stocked products P and products P planned to be produced are allocated for the respective demands based on the finished product stock information d3 and the production plan/reply plan information d9. In the example shown in FIG. 16, the production state in each record associated with a demand for which a stocked product P is allocated is shown as “Product in stock”. In the record for a to-be-produced product P, the production condition indicates, for example, that it is a product P with an allocation material, instead of showing “Produced” or the like.

Note that in the records for products P which have already been shipped out, or in the records associated with demands for which stocked products P are allocated (namely, the records with the production state showing “Product in stock”), the planned production date and the for-reply planned date are not set. In the example shown in FIG. 16, the planned production dates and the for-reply planned dates in such records are each shown as “—”.

Also, in the customer-directed reply information d10, each product P not allocated for a demand among the products P with the set planned production dates is presented, for each planned production date, as an order subject product for which an order has not been determined. In the example shown in FIG. 16, the customer, the demand status, the desired delivery time, and the shipping date in each record for such a product P not allocated for a demand are shown as “—”. It is assumed that the demanded quantity in this record equals the quantity not allocated for a demand among the quantity of the products P with the respective set planned production date.

The number of production plan extra days refers to, for example, the number of days from a corresponding planned production date to a corresponding desired delivery time. Note that the number of production plan extra days in each record for an already-shipped product P is not calculated, as the product P is already sent out. In the example shown in FIG. 16, the number of production plan extra days in such a record without calculation of the number of production plan extra days due to shipment completion is shown as “—”. The number of production plan extra days in the record with the production state of a product P showing “Product in stock” is also not calculated, since the stocked product P is allocated. In the example shown in FIG. 16, the number of production plan extra days in the record without calculation of the number of production plan extra days due to allocation of a stocked product P is shown as “—(In stock)”. Also, the number of production plan extra days in the record for a product P not allocated for a demand is undeterminable since no desired delivery time is determined. In the example shown in FIG. 16, the number of production plan extra days in each record with an undeterminable number of production plan extra days due to the absence of the determined desired delivery time is shown as “NA”.

The number of reply plan extra days refers to, for example, the number of days from a corresponding for-reply planned date to a corresponding desired delivery time. Note that the number of replay plan extra days in each record for an already-shipped product P is not calculated, as the product P has already been sent out. In the example shown in FIG. 16, the number of reply plan extra days in such a record without calculation of the number of reply plan extra days due to shipment completion is shown as “—”. The number of reply plan extra days in the record with the production state of a product P showing “Product in stock” is also not calculated, since the stocked product P is allocated. In the example shown in FIG. 16, the number of reply plan extra days in the record without calculation of the number of reply plan extra days due to allocation of a stocked product P is shown as “—(In stock)”. Also, the number of reply plan extra days in the record for a product P not allocated for a demand is undeterminable since no desired delivery time is determined. The number of reply plan extra days in the record with an undetermined for-reply planned date is also undeterminable. In the example shown in FIG. 16, the number of reply plan extra days in each record with an undeterminable number of reply plan extra days is shown as “NA”.

The customer-directed reply gives, in one example, a date or a schedule which enables the delivery of a product P for the respective demand and which is based on the number of reply plan extra days. In each of the record with the number of reply plan extra days being a positive number, and the record with a stocked product P allocated, the customer-directed reply conforms to the desired delivery time since this desired delivery time can be met. In each of the record for an already shipped product P and the record with an undeterminable number of reply plan extra days, the customer-directed reply, for example, forgoes giving a concrete date or schedule. In the example shown in FIG. 16, the customer-directed reply in the record without a concrete date or schedule for reply to the customer is shown as “—”. While not shown in the figure, the customer-directed reply in the record with the number of reply plan extra days being a negative number may conform to, as one example, the for-reply planned date, since the delivery is not possible within the desired delivery time.

In the customer-directed reply information d10 as shown in, for example, FIG. 16 explained above, the third record indicates, for the product PA which is an order subject product appearing in the third record in the demand information d6 shown in FIG. 12, that a stocked product PA is allocated, that the number of production plan extra days and the number of reply plan extra days are both “—(In stock)”, and that the customer-directed reply gives March 15. Also as another example, the fourth record in FIG. 16 indicates, for the product PB which is an order subject product appearing in the fourth record in the demand information d6 shown in FIG. 12, that a product PB with the production state “Step SB1” is allocated, that the planned production date and the for-reply planned date for the allocated part are both March 20, that the number of production plan extra days and the number of reply plan extra days are both 0 (zero), and that the customer-directed reply gives March 20. Also as yet another example, the fifteenth record in FIG. 16 indicates, for the product PB which is not allocated for any record in the demand information d6 shown in FIG. 12, that the production state is “Reply”, that the planned production date and the for-reply planned date are April 10 and April 20, respectively, that the delayed part is a part M2, and that the number of production plan extra days and the number of reply plan extra days are both undeterminable.

### Part Request Information d11

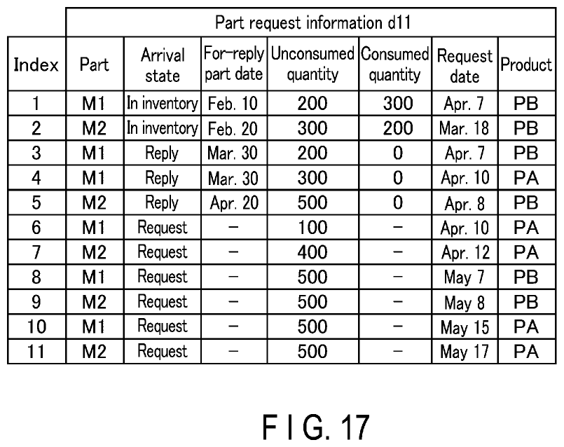

The part request information d11 will be explained with reference to FIG. 17. FIG. 17 is a table for explaining an example of the part request information d11 generated by the planning system 1 according to an embodiment.

The part request information d11 is information based on the allocation information d8 and relates to the parts M for use in the production of products P on the respective planned production dates. The part request information d11 contains, in one example, information on parts M, arrival states, for-reply part dates, unconsumed quantities, consumed quantities, request dates, and products P. In the part request information d11, for example, each combination of a part M, an arrival state, a for-reply part date, an unconsumed quantity, a consumed quantity, a request date, and a product P is retained. The for-reply part date in each record for a part M expected to arrive is undeterminable. In this record, the unconsumed quantity conforms to the planned allocation quantity of the allocation material allocated for the production of products P on the request date in the allocation information d8.

In the part request information d11 as shown in, for example, FIG. 17, the first record indicates, for the parts M1 which arrived on February 10 as appearing in the first record in the part inventory/reply information d1 shown in FIG. 7, that the request date for 200 unconsumed parts M1 is April 7, that there are 300 consumed parts M1 which arrived on February 10, and that these 200 unconsumed parts M1 are allocated for the production of products PB. Also, as another example, the sixth record in FIG. 17 indicates, for the parts M1 with the arrival state “Request”, that the request date for 100 unconsumed parts M1 is April 10, and that these 100 unconsumed parts M1 are allocated for the production of products PA.

### Monthly Summary Information d12

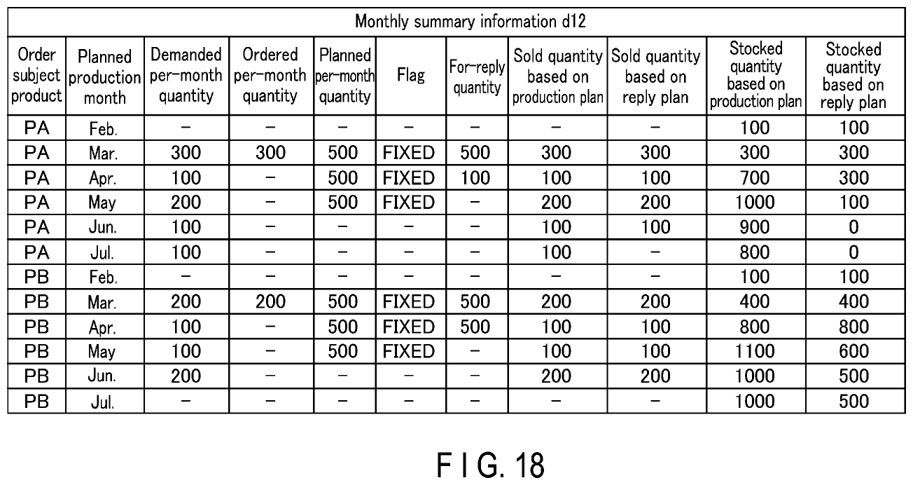

The monthly summary information d12 will be explained with reference to FIG. 18. FIG. 18 is a table for explaining an example of the monthly summary information d12 generated by the planning system 1 according to an embodiment.

The monthly summary information d12 contains, in one example, information on order subject products, planned production months, demanded per-month quantities, ordered per-month quantities, planned per-month quantities, flags, for-reply quantities, sold quantities based on production plans, sold quantities based on reply plans, stocked quantities based on the production plans, and stocked quantities based on the reply plans. In the monthly summary information d12, for example, a demanded per-month quantity, an ordered per-month quantity, a planned per-month quantity, a flag, a for-reply quantity, a sold quantity based on a production plan, a sold quantity based on a reply plan, a stocked quantity based on the production plan, and a stocked quantity based on the reply plan are retained for each combination of an order subject product and a planned production month.

The demanded per-month quantity refers to, for example, the sum of demanded quantities appearing in the records in the demand information d6 which are associated with the same product P and of which desired delivery times fall within the same planned production month. The demanded per-month quantity for the planned production month without a demand is shown as “—”.

The ordered per-month quantity refers to, for example, the sum of demanded quantities appearing in the records in the demand information d6 which are associated with the same product P, of which desired delivery times fall within the same planned production month, and which all indicate a demand status “Order received”. The ordered per-month quantity for the planned production month that does not involve an order subject product with the demand status “Order received” is shown as “—”.

The for-reply quantity refers to, for example, the sum of demanded quantities appearing in the records in the customer-directed reply information d10 which are associated with the same product P and of which for-reply planned dates fall within the same planned production month. If there are no for-reply planned date in a given planned production month, the for-reply quantity for this planned production month is shown as “—”. Note that the for-reply quantity also conforms to the sum of the produced quantities and the planned partial quantities in the production plan/reply plan information d9 for which the for-reply planned dates fall within the same planned production month.

The sold quantity based on a production plan refers to, for example, the sold quantity of each product P calculated based on a production plan. The sold quantity based on a production plan is the sum of demanded quantities appearing in some of the records in the customer-directed reply information d10 of which desired delivery times fall within the same planned production month and which are the records for already shipped products P, the records for stocked products P, and the records for products P each with a planned production date having a time to the desired delivery time (i.e., the records with the number of production plan extra days being “—”, “—(In stock)”, or a positive number). The demanded quantities of the products P for which the number of production plan extra days is undeterminable are not included in this sold quantity based on the production plan.

The sold quantity based on a reply plan refers to, for example, the sold quantity of each product P calculated based on a reply plan. The sold quantity based on a reply plan is the sum of demanded quantities appearing in some of the records in the customer-directed reply information d10 of which desired delivery times fall within the same planned production month and which are the records for already shipped products P, the records for stocked products P, and the records for products P each with a for-reply planned date having a time to the desired delivery time (i.e., the records with the number of reply plan extra days being “—”, “—(In stock)”, or a positive number). The demanded quantities of the products P for which the number of reply plan extra days is undeterminable are not included in this sold quantity based on the reply plan.

The stocked quantity based on a production plan refers to, for example, the stocked quantity of a product P which takes into account the sold quantity based on the production plan and the planned per-month quantity for a given planned production month and which is an expected quantity for the end of this planned production month. The stocked quantity based on the production plan for a month (e.g., February in this exemplary embodiment) immediately preceding the planning month equals the stocked quantity as of the end of the preceding month as indicated in the finished product stock information d3.

The stocked quantity based on a reply plan refers to, for example, the stocked quantity of a product P which takes into account the sold quantity based on the reply plan and the planned per-month quantity for a given planned production month, and which is an expected quantity for the end of this planned production month. The stocked quantity based on the reply plan for a planned production month immediately preceding the planning month equals the stocked quantity based on the production plan for this planned production month.

### 1.5 Operations

Next, planning operations conducted with the planning system 1 according to one or more embodiments will be described.

### 1.5.1 Planning Operations

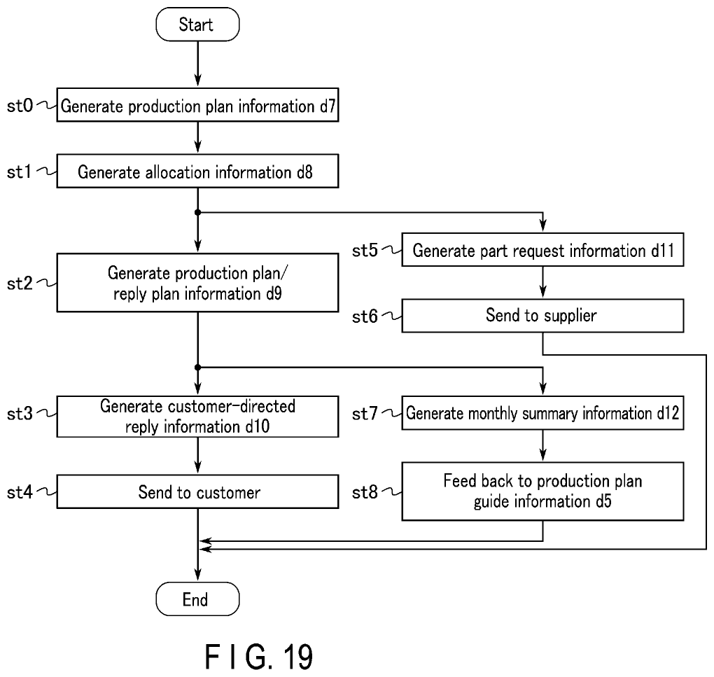

FIG. 19 will be referred to for explaining an overall flow of the planning operations. FIG. 19 is a flowchart for explaining an exemplary planning operation conducted with the planning system 1 according to an embodiment.

In st0, the production planning unit 20 generates production plan information d7. The production planning unit 20 determines planned production dates and planned partial quantities so that the sum of produced quantities and planned partial quantities for the planned production dates within a planned production month equals the planned per-month quantity of this planned production month in the production plan guide information d5.

In st1, the allocating unit 21 generates allocation information d8. That is, the allocating unit 21 allocates materials for the production of products P on each planned production date. The allocation of materials may be simply called an “allocation process”. The allocation process will be described in more detail later.

In st2, the per-product reply preparing unit 22 generates production plan/reply plan information d9. Generation of the production plan/reply plan information d9 will be described in more detail later.

In st3, the customer-directed reply preparing unit 23 generates customer-directed reply information d10. Generation of the customer-directed reply information d10 will be described in more detail later.

In st4, the customer-directed reply information d10 is sent to each customer.

In st5, the part request preparing unit 24 generates part request information d11.

More specifically, the part request preparing unit 24 selects the records in the allocation information d8 that indicate parts M1 and M2 to be allocation materials. In one example, the part request preparing unit 24 generates the part request information d11 with records corresponding to the selected records in the allocation information d8, respectively. Here, the part request preparing unit 24 calculates a for-reply part date, an unconsumed quantity, and a consumed quantity for each record indicating a product, a part, an arrival state, and a request date in the part request information d11.

The part request preparing unit 24 determines, for each of the records with the arrival state “In inventory” or “Reply”, the for-reply part date in the part request information d11 based on the part inventory/reply information d1. For the record with the arrival state “Request”, the part request preparing unit 24 sets the for-reply part date to be undeterminable.

Also, the part request preparing unit 24 sets the unconsumed quantity in each record to be equal to the planned allocation quantity appearing in the corresponding record in the allocation information d8.

In one example, the part request preparing unit 24 also sets the consumed quantity appearing in one of the records in the part request information d11 for the part M with the arrival state “In inventory” to be the same as the consumed quantity of the corresponding part in the part inventory/reply information d1. While not shown in FIG. 17, in the case where more than one record in the part request information d11 is for the part M with the arrival state “In inventory”, the part request preparing unit 24 sets the consumed quantity in, for example, each of these records except one record to 0 (zero). The part request preparing unit 24 sets the consumed quantity appearing in the record with the arrival state “Reply” in the part request information d11 to be 0 (zero) since no consumed parts M exist. The part request preparing unit 24 sets the consumed quantity appearing in the record with the arrival state “Request” in the part request information d11 to “—” since no parts M have arrived.

In st6, the part request information d11 is sent to the supplier X.

In st7, the monthly summary preparing unit 25 generates monthly summary information d12. Generation of the monthly summary information d12 will be described in more detail later.

In st8, in one example, the monthly summary information d12 is fed back to the production plan guide information d5.

Upon completion of all of the processes in st4, st6, and st8, the planning operations are ended.

### 1.5.2 Process to Generate Allocation Information

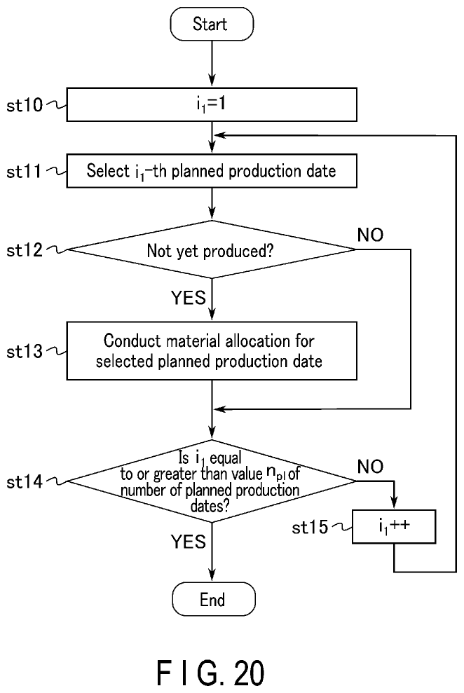

Generation of allocation information d8 will be explained with reference to FIG. 20. FIG. 20 is a flowchart for explaining an exemplary generation of the allocation information d8 conducted with the planning system 1 according to an embodiment.

The allocating unit 21 allocates materials for not-yet-produced products P among the products P associated with each planned production date in the production plan information d7.

In st10, the allocating unit 21 initializes a variable i₁ to 1. The processing flow then proceeds to st11.

In st11, the allocating unit 21 selects the i₁-th planned production date which is the earliest planned production date. The processing flow then proceeds to st12.

In st12, the allocating unit 21 judges whether or not the product P associated with the selected planned production date has already been produced, based on the production plan information d7. If it is not an already-produced product P (st12; YES), the processing flow proceeds to st13. If it is an already-produced product P (st12; NO), a record is prepared for this produced product P in the allocation information d8. The processing flow then proceeds to st14.

In st13, the allocating unit 21 conducts material allocation for the selected planned production date. The material allocation is constituted by allocating an allocation material or materials for the product P associated with the selected planned production date, and preparing a record for each allocated allocation material in the allocation information d8. The material allocation will be described in more detail later. The processing flow then proceeds to st14.

In st14, the allocating unit 21 judges whether or not the variable in is equal to or greater than a value nₚₗ of the number of planned production dates in the production plan information d7. If the variable in is equal to or greater than the value nₚₗ (st14; YES), the processing is ended. If the variable i₁ is less than the value nₚₗ (st14; NO), the processing flow proceeds to st15. Note that, in an illustrative example according to an embodiment, the value nₚₗ (the number of records in the production plan information d7) is 8.

In st15, the allocating unit 21 increments the variable in and the processing flow proceeds to st11. In the manner as described above, the allocating unit 21 repeats the processing from st11 to st15 until it judges that the variable i₁ is equal to the value nₚₗ (st14; YES).

The processing is thus ended.

### 1.5.2.1 Allocation of Materials

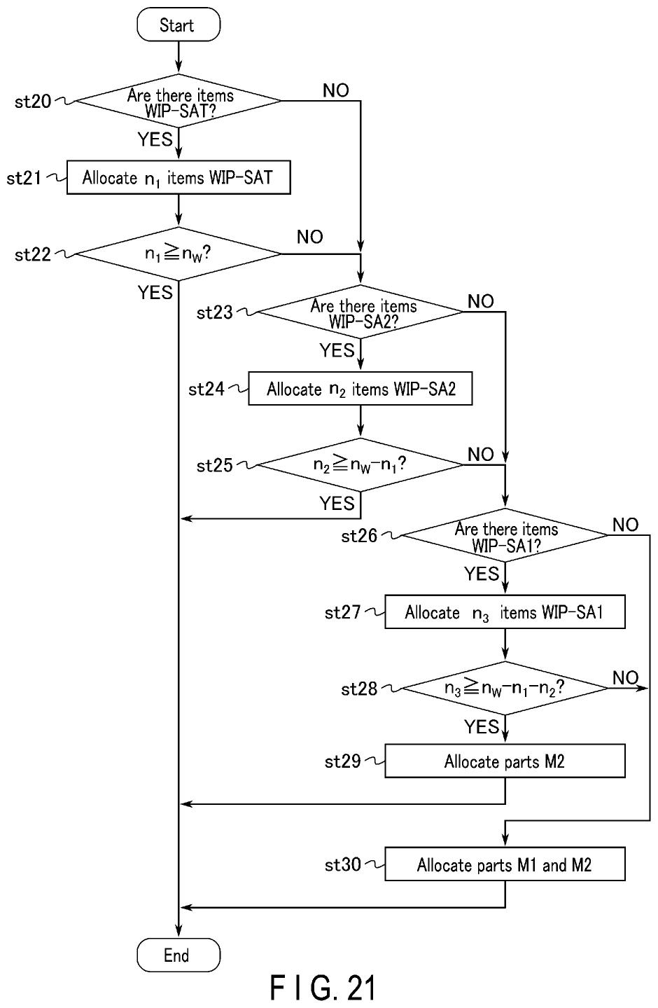

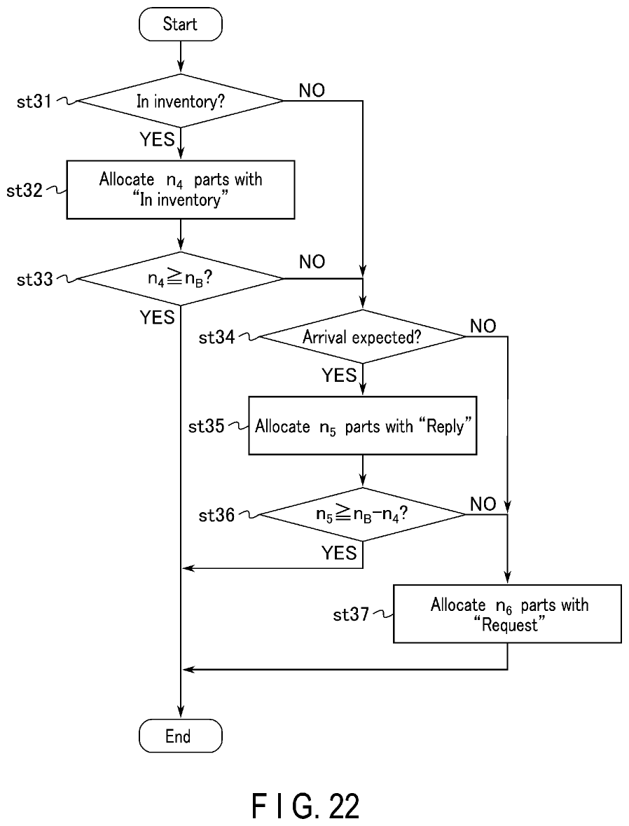

The material allocation in st13 will be further explained with reference to FIGS. 21 and 22. FIGS. 21 and 22 are each a flowchart for explaining one example of the material allocation conducted with the planning system 1 according to an embodiment. The description will concentrate on the case of a plan where products PA are produced on the selected planned production date, and an explanation of the case of a plan where products PB are produced on the selected planned production date will be omitted.

In the material allocation, the allocating unit 21 first allocates, with priority, work-in-progress items WIP having a short remaining lead time LTrm. That is, in this example, the allocating unit 21 allocates work-in-progress items WIP-SAT, then work-in-progress items WIP-SA2, and then work-in-progress items WIP-SA1 for the products PA. The allocating unit 21 then allocates parts M for the products PA to which the work-in-progress items WIP have not been allocated.

In st20, the allocating unit 21 judges whether or not there are work-in-progress items WIP-SAT which have not been allocated. If there are not-yet-allocated work-in-progress items WIP-SAT (st20; YES), the processing flow proceeds to st21. If there are no such not-yet-allocated work-in-progress items WIP-SAT (st20; NO), the processing flow proceeds to st23.

In st21, as one example, the allocating unit 21 allocates, from the not-yet-allocated work-in-progress items WIP-SAT, n₁ work-in-progress items WIP-SAT for the production on the planned production date selected in st11. If the number of the not-yet-allocated work-in-progress items WIP-SAT is less than the value n_{w} of the planned partial quantity, the value (number) n₁ conforms to the number of the not-yet-allocated work-in-progress items WIP-SAT. If the number of the not-yet-allocated work-in-progress items WIP-SAT is equal to or greater than the value n_{w}, the value n₁ conforms to the value nw.

The allocating unit 21 also prepares the record in the allocation information d8 for the work-in-progress items WIP-SAT allocated as above. Specifically, the allocating unit 21 determines the status (work-in-progress step) of the allocation material, allocation identifiers (part identifiers for parts M1 and M2), a planned allocation quantity, an actual allocation quantity, a reply-possible production date, and a for-reply production date. The allocating unit 21 sets the planned allocation quantity and the actual allocation quantity for the work-in-progress items WIP-SAT to be the same as the value n₁. The allocating unit 21 sets the reply-possible production date for the work-in-progress items WIP to be a date which is later than the planning date by the remaining lead time LTrm for the work-in-progress items. The allocating unit 21 sets the for-reply production date to be either the planned production date or the reply-possible production date, whichever is later.

The processing flow then proceeds to st22.

In st22, the allocating unit 21 judges whether or not the value n₁ is equal to or greater than the value n_{w}. If the value n₁ is equal to or greater than the value n_{w} (st22; YES), the material allocation is ended. If the value n₁ is less than the value n_{w} (st22; NO), the processing flow proceeds to st23.

In st23, the allocating unit 21 judges whether or not there are work-in-progress items WIP-SA2 which have not been allocated. If there are not-yet-allocated work-in-progress items WIP-SA2 (st23; YES), the processing flow proceeds to st24. If there are no such not-yet-allocated work-in-progress items WIP-SA2 (st23; NO), the processing flow proceeds to st26.

In st24, as one example, the allocating unit 21 allocates, from the not-yet-allocated work-in-progress items WIP-SA2, n₂ work-in-progress items WIP-SA2 for the production on the planned production date selected in st11. If the number of the not-yet-allocated work-in-progress items WIP-SA2 is less than the value [n_{w}−n₁], the value (number) n₂ conforms to the number of the not-yet-allocated work-in-progress items WIP-SA2. If the number of the not-yet-allocated work-in-progress items WIP-SA2 is equal to or greater than the value [n_{w}−n₁], the value n₂ conforms to the value [n_{w}−n₁].

The allocating unit 21 also prepares the record in the allocation information d8 for the allocated work-in-progress items WIP-SA2. Specifically, the allocating unit 21 determines the status of the allocation material, allocation identifiers, a planned allocation quantity, an actual allocation quantity, a reply-possible production date, and a for-reply production date. The allocating unit 21 sets the planned allocation quantity and the actual allocation quantity for the work-in-progress items WIP-SA2 to be the same as the value n₂. Also, the allocating unit 21 sets the status of the allocation material, the allocation identifiers, the reply-possible production date, and the for-reply production date in a similar manner to the processing in st21.

The processing flow then proceeds to st25.

In st25, the allocating unit 21 judges whether or not the value n₂ is equal to or greater than the value [n_{w}−n₁]. If the value n₂ is equal to or greater than the value [n_{w}−n₁] (st25; YES), the material allocation is ended. If the value n₂ is less than the value [n_{w}−n₁] (st25; NO), the processing flow proceeds to st26.

In st26, the allocating unit 21 judges whether or not there are work-in-progress items WIP-SA1 which have not been allocated. If there are not-yet-allocated work-in-progress items WIP-SA1 (st26; YES), the processing flow proceeds to st27. If there are no such not-yet-allocated work-in-progress items WIP-SA1 (st26; NO), the processing flow proceeds to st30.

In st27, the allocating unit 21 allocates, from the not-yet-allocated work-in-progress items WIP-SA1, n₃ work-in-progress items WIP-SA1 for the production on the planned production date selected in st11. If the number of the not-yet-allocated work-in-progress items WIP-SA1 is less than the value [n_{w}−n₁−n₂], the value (number) n₃ conforms to the number of the not-yet-allocated work-in-progress items WIP-SA1. If the number of the not-yet-allocated work-in-progress items WIP-SA1 is equal to or greater than the value [n_{w}−n₁−n₂], the value n₃ conforms to the value [n_{w}−n₁−n₂].

The allocating unit 21 also prepares the record in the allocation information d8 for the allocated work-in-progress items WIP-SA1. Specifically, the allocating unit 21 determines the status of the allocation material, allocation identifiers, a planned allocation quantity, an actual allocation quantity, a reply-possible production date, and a for-reply production date. The allocating unit 21 sets the planned allocation quantity and the actual allocation quantity for the work-in-progress items WIP-SA1 to be the same as the value n₃. Also, the allocating unit 21 sets the status of the allocation material, the allocation identifiers, the reply-possible production date, and the for-reply production date in a similar manner to the processing in st21 and st24.

The processing flow then proceeds to st28.

In st28, the allocating unit 21 judges whether or not the value n₃ is equal to or greater than the value [n_{w}−n₁−n₂]. If the value n₃ is equal to or greater than the value [n_{w}−n₁−n₂] (st28; YES), the material allocation is ended. If the value n₃ is less than the value [n_{w}−n₁−n₂] (st28; NO), the processing flow proceeds to st29.

In st29, the allocating unit 21 allocates parts M2. Specifically, the parts M2 for use in the production of products PA with the work-in-progress items WIP-SA1 are allocated in the number that conforms to the value n₃, i.e., the number equal to the number of the allocated work-in-progress items WIP-SA1. The allocation of parts M will be described in more detail later. The processing is then ended.

In st30, the allocating unit 21 allocates parts M1 and M2. If the work-in-progress items WIP-SA1 are allocated (st26; YES), the allocating unit 21 allocates [n_{w}−n₁−n₂] parts M1 and [n_{w}−n₁−n₂-n₃] parts M2 for the products PA. If the work-in-progress items WIP-SAI are not allocated (st26; NO), the allocating unit 21 allocates [n_{w}−n₁−n₂] parts M1 and M2 for the products PA. The allocation of each part M is conducted in a similar manner to the processing in st29. The processing is then ended.

In instances where it is planned that products PB are produced on the selected planned production date, substantially the same processing steps as st20 to st30 are conducted on the condition that the products PB and the work-in-progress items WIP-SBT, WIP-SB1, and WIP-SB2 instead of the products PA and the work-in-progress items WIP-SAT, WIP-SA1, and WIP-SA2 are subjected to the processing.

Next, the allocation of each part M in the processing in st29 and st30 will be explained with reference to FIG. 22.

In the allocation of parts M, the allocating unit 21 preferentially allocates parts M with the arrival state “In inventory” and parts M with the arrival state “Reply” in this order. If there are no parts M with the arrival state “In inventory” or “Reply”, the allocating unit 21 allocates parts M with the arrival state “Request”, assuming that an order is to be given.

In st31, the allocating unit 21 judges whether or not there are parts M which have not been allocated and which have the arrival state “In inventory”. If there are not-yet-allocated parts M with the arrival state “In inventory” (st31; YES), the processing flow proceeds to st32. If there are no such not-yet-allocated parts M with the arrival state “In inventory” (st31; NO), the processing flow proceeds to st34.

In st32, the allocating unit 21 allocates, from the not-yet-allocated parts M with the arrival state “In inventory”, n₄ parts M for the production on the planned production date selected in st11. If the number of the not-yet-allocated parts M with the arrival state “In inventory” is less than a value n_{B}, the value (number) n₄ conforms to this number of the parts M. The value n_{B} refers to the number of each type of products M allocated in st29 and st30 explained above. If the number of the not-yet-allocated parts M with the arrival state “In inventory” is equal to or greater than the value n_{B}, the value n₄ conforms to the value n_{B}.

The allocating unit 21 also prepares the record in the allocation information d8 for the parts M allocated as above. Specifically, the allocating unit 21 determines the status (arrival state) of the allocation material, an allocation identifier (part identifier), a planned allocation quantity, an actual allocation quantity, a reply-possible production date, a for-reply production date, and a request date. The allocating unit 21 sets the planned allocation quantity and the actual allocation quantity to be the same as the value n₄. The allocating unit 21 sets the reply-possible production date to be a date which is later than the planning date by the required lead time LTrq for the parts M. The allocating unit 21 sets the for-reply production date in a similar manner to the processing in st22, st24, and st27. The allocating unit 21 sets the request date to be a date which is earlier than the planning date by the required lead time LTrq for the parts M.

In st33, the allocating unit 21 judges whether or not the value n₄ is equal to or greater than the value n_{B}. If the value n₄ is equal to or greater than the value n_{B} (st33; YES), the allocation of each part M is ended. If the value n₄ is less than the value n_{B} (st33; NO), the processing flow proceeds to st34.

In st34, the allocating unit 21 judges whether or not there are parts M which have not been allocated and which have the arrival state “Reply” (which are expected to arrive). If there are not-yet-allocated parts M with the arrival state “Reply” (st34; YES), the processing flow proceeds to st35. If there are no such not-yet-allocated parts M with the arrival state “Reply” (st34; NO), the processing flow proceeds to st37.

In st35, the allocating unit 21 allocates, from the not-yet-allocated parts M with the arrival state “Reply”, n₅ parts M for the production on the planned production date selected in st11. If the number of the not-yet-allocated parts M with the arrival state “Reply” is less than the value [n_{B}−n₄], the value (number) n₅ conforms to this number of the parts M. If the number of the not-yet-allocated parts M with the arrival state “Reply” is equal to or greater than the value [n_{B}−n₄], the value n₅ conforms to the value [n_{B}−n₄].

The allocating unit 21 also prepares the record in the allocation information d8 for the parts M allocated as above. Specifically, the allocating unit 21 determines the status of the allocation material, an allocation identifier, a planned allocation quantity, an actual allocation quantity, an expected arrival date (a for-reply part date), a reply-possible production date, a for-reply production date, and a request date. The allocating unit 21 sets the planned allocation quantity and the actual allocation quantity to be the same as the value n₅. The allocating unit 21 sets the reply-possible production date, the for-reply production date, and the request date in a similar manner to the processing in st32.

In st36, the allocating unit 21 judges whether or not the value n₅ is equal to or greater than the value [n_{B}−n₄]. If the value n₅ is equal to or greater than the value [n_{B}−n₄] (st36; YES), the allocation of each part M is ended. If the value n₄ is less than the value [n_{B}−n₄] (st36; NO), the processing flow proceeds to st37.

In st37, the allocating unit 21 allocates n₆ parts M which have the arrival state “Request” (and are to be ordered) for the production on the planned production date selected in st11. The value (number) n₆ conforms to the value [n_{B}−n₄−n₅].

The allocating unit 21 also prepares the record in the allocation information d8 for the parts M allocated as above. Specifically, the allocating unit 21 determines the status of the allocation material, an allocation identifier, a planned allocation quantity, an actual allocation quantity, an expected arrival date, a reply-possible production date, a for-reply production date, a request quantity, and a request date. The allocating unit 21 sets the planned allocation quantity and the request quantity to be the same as the value n₆. Also, the allocating unit 21 sets the expected arrival date, the reply-possible production date, and the for-reply production date to be undeterminable. The allocating unit 21 sets the request date in a similar manner to the processing in st32 and st35.

The allocation of each part M is thus ended.

### 1.5.3 Generation of Production Plan/Reply Plan Information

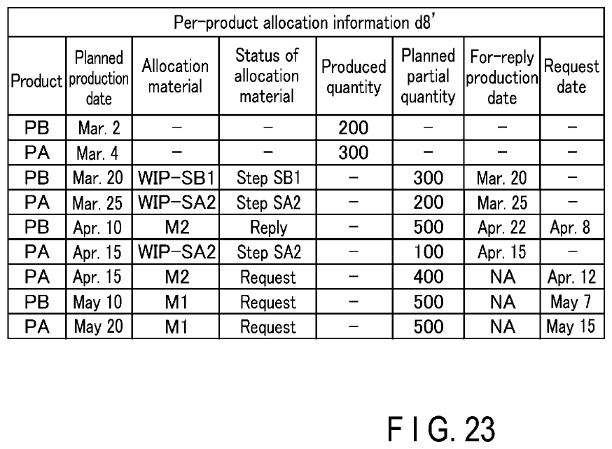

Generation of production plan/reply plan information d9 will be explained with reference to FIG. 23. By way of example, FIG. 23 shows allocation information d8′ per product for the generation of production plan/reply plan information d9.

The per-product allocation information d8′ contains, in one example, information on products, planned production dates, allocation materials, statuses of the allocation materials, produced quantities, planned partial quantities, for-reply production dates, and request dates.

The per-product reply preparing unit 22 selects, from among the records included in the allocation information d8 and associated with the respective combinations of a product P and a planned production date, a record indicating the latest for-reply production date. In one example, for generating the per-product allocation information d8′, the per-product reply preparing unit 22 may select multiple records indicating different for-reply production dates and including the latest for-reply production date from among the records included in the allocation information d8 and associated with the respective combinations of a product P and a planned production date.

The per-product reply preparing unit 22 prepares records in the per-product allocation information d8′ corresponding to the records in the allocation information d8 which have been selected as above.

In the example shown in FIG. 23, multiple records are prepared for the products PA with the planned production date of April 15, namely, a record in which the allocation material is the work-in-progress items WIP-SA2 and the for-reply production date is April 15, and a record in which the allocation material is the parts M2 and the for-reply production date is undeterminable. For each of the other planned production dates, one record is prepared.

In generating the per-product allocation information d8′ in which one record is prepared for each planned production date for each type of the products P, the per-product reply preparing unit 22 sets the planned partial quantity in each record to be the same as the planned per-day quantity of the respective planned production date. Here, if, for example, multiple records are prepared for each planned production date for each type of the products P, the per-product reply preparing unit 22 prepares such multiple records so that the sum of the planned partial quantities therein equals the planned per-day quantity on the respective planned production date.

Note that, while not shown in the figure, the per-product allocation information d8′ may be presented together with the allocation information d8 as shown in FIG. 14.

Next, the per-product reply preparing unit 22 generates the production plan/reply plan information d9 based on the per-product allocation information d8′. More specifically, and for example, the per-product reply preparing unit 22 prepares records in the production plan/reply plan information d9 corresponding to the respective records in the per-product allocation information d8′. That is, the per-product reply preparing unit 22 determines a for-reply planned date, a production state, and a delayed part for each combination of a product P, a planned production date, a produced quantity, and a planned partial quantity.

If the for-reply production date appearing in the record in the per-product allocation information d8′ is either a concrete date or undeterminable (“NA”), the per-product reply preparing unit 22 sets the for-reply planned date to be the planned production date or the for-reply production date, whichever is later. If the record in the per-product allocation information d8′ is associated with already-produced products P (with the allocation material showing “—”), the per-product reply preparing unit 22 sets the for-reply planned date to be the same as the planned production date.

If the record in the per-product allocation information d8′ is associated with not-yet-produced products P, the per-product reply preparing unit 22 sets the production state to be the same as the status of the allocation material. Also, if the record in the per-product allocation information d8′ is associated with already-produced products P, the per-product reply preparing unit 22 sets the production state to “Produced”.

If the record in the per-product allocation information d8′ indicates that the allocation material is a part M and the request date is later than the planned production date, the per-product reply preparing unit 22 sets the delayed part to be this part M. If the record in the per-product allocation information d8′ indicates that the allocation material is a work-in-progress item WIP and the request date is the same as, or earlier than, the planned production date, the per-product reply preparing unit 22 sets no delayed part.

### 1.5.4 Generation of Customer-Directed Reply Information

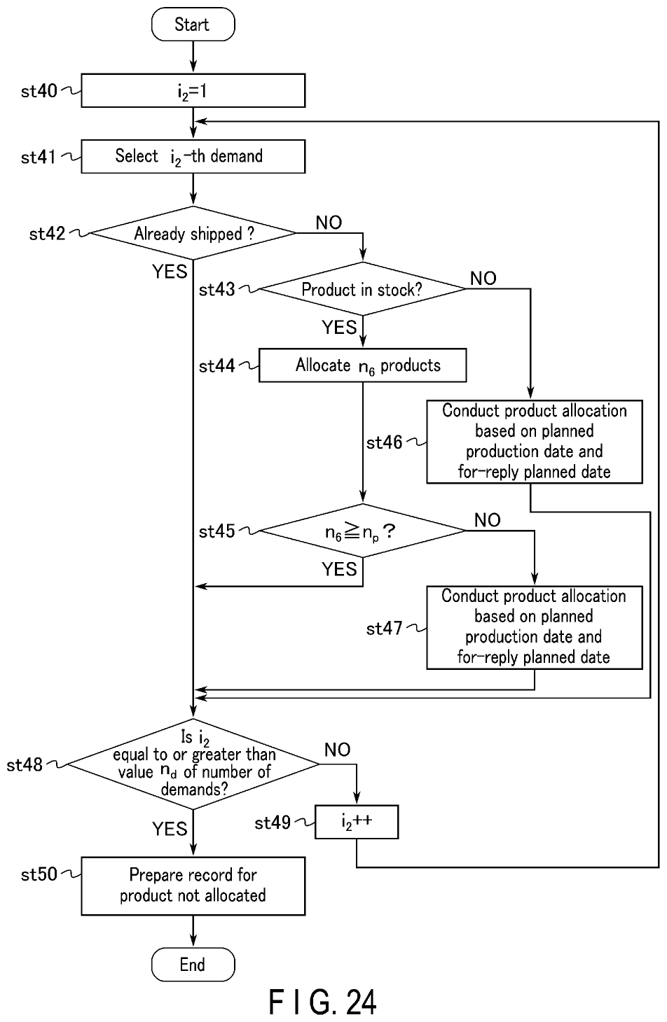

Generation of customer-directed reply information d10 in st3 will be explained with reference to FIG. 24. FIG. 24 is a flowchart for explaining an exemplary generation of the customer-directed reply information d10 conducted with the planning system 1 according to an embodiment.

In one example, in generating the customer-directed reply information d10, the customer-directed reply preparing unit 23 allocates stocked products P to each demand in the demand information d6 with a priority over not-yet-stocked products P (products planned to be produced), based on the finished product stock information d3 and the production plan/reply plan information d9. The not-yet-stocked products P refer to the products P appearing in the records for which a planned partial quantity is set in the production plan/reply plan information d9. The customer-directed reply preparing unit 23 also allocates the not-yet-stocked products P to each demand based on the planned production date and the for-reply planned date indicated in the production plan/reply plan information d9.

In st40, the customer-directed reply preparing unit 23 initializes a variable i₂ to 1. The processing flow then proceeds to st41.

In st41, the customer-directed reply preparing unit 23 selects the i₂-th demand with the earliest desired delivery time. The processing flow then proceeds to st42.

In st42, the customer-directed reply preparing unit 23 judges whether or not the products P in the selected demand are already shipped products. If the products P are already shipped products (st42; YES), the customer-directed reply preparing unit 23 prepares a record in the customer-directed reply information d10 which indicates, for the selected demand, that the products P are already shipped products. The processing flow then proceeds to st48. If the products P are not the already shipped products (st42; NO), the processing flow proceeds to st43.

In st43, the customer-directed reply preparing unit 23 judges, for the products P in the selected demand, whether or not there are products P which have not been allocated among the stocked products P, based on the production plan/reply plan information d9. If there are not-yet-allocated stocked products P (st43; YES), the processing flow proceeds to st44. If there are no such not-yet-allocated stocked products P (st43; NO), the processing flow proceeds to st46.

In st44, the customer-directed reply preparing unit 23 allocates n₆ stocked products P to the selected demand. If the number of the not-yet-allocated stocked products P is less than a value n_{P}, the value (number) n₆ conforms to the number of the not-yet-allocated stocked products P. The value n₆ here refers to the demanded quantity in the selected demand. If the number of the not-yet-allocated stocked products P is equal to or greater than the value n_{P}, the value n₆ conforms to the value n_{P}.

Also, the customer-directed reply preparing unit 23 prepares the record in the customer-directed reply information d10 for the selected demand. The customer-directed reply preparing unit 23 sets the production state to “Product in stock”, indicating allocation of the stocked products. The customer-directed reply preparing unit 23 sets each of the planned production date, the for-reply planned date, and the delayed part to none. The customer-directed reply preparing unit 23 sets the number of production plan extra days and the number of reply plan extra days to “—(In stock)”. The customer-directed reply preparing unit 23 sets the customer-directed reply to be the same as the desired delivery time.

The processing flow then proceeds to st45.

In st45, the customer-directed reply preparing unit 23 judges whether or not the value n₆ is equal to or greater than the value n_{P}. If the value n₆ is equal to or greater than the value n_{P} (st45; YES), the processing flow proceeds to st48. If the value n₆ is less than the value n_{P} (st45; NO), the processing flow proceeds to st47.

In st46, the customer-directed reply preparing unit 23 allocates, for the products P in the selected demand, n_{P} products P from not-yet-produced and not-yet-allocated products P in the order from the earliest planned production date associated with them, based on the production plan/reply plan information d9. In instances where the production plan/reply plan information d9 includes multiple records with the same planned production date, the customer-directed reply preparing unit 23 preferentially allocates products P with an earlier for-reply planned date among the not-yet-allocated products P.

Also, the customer-directed reply preparing unit 23 prepares the record in the customer-directed reply information d10 for the selected demand. The customer-directed reply preparing unit 23 sets the production state, the planned production date, the for-reply planned date, and the delayed part to be the same as the production state, the planned production date, the for-reply planned date, and the delayed part in the record for the allocated products P, respectively. The customer-directed reply preparing unit 23 also sets, as the number of production plan extra days and the number of reply plan extra days, respectively, the number of days from the planned production date to the desired delivery time and the number of days from the for-reply planned date to the desired delivery time. Note that if the planned production date and the for-reply planned date are undeterminable, the number of production plan extra days and the number of reply plan extra days are set to be undeterminable, either. If the number of reply plan extra days is a positive number, the customer-directed reply preparing unit 23 sets the customer-directed reply to be the same as the desired delivery time, as delivery within the desired delivery time is possible. While not shown in the figure, if the number of reply plan extra days is a negative number, the customer-directed reply preparing unit 23 sets the customer-directed reply to be the same as, for example, the for-reply planned date, as delivery within the desired delivery time is not possible. If the number of reply plan extra days is undeterminable, the customer-directed reply preparing unit 23 sets the customer-directed reply to be undeterminable.

The processing flow then proceeds to st48.

In st47, the customer-directed reply preparing unit 23 allocates, for the products P in the selected demand to which the stocked products P have not been allocated, [n_{P}−n₆] products P from not-yet-produced and not-yet-allocated products P, in a similar manner to st46. Also, the customer-directed reply preparing unit 23 prepares the record in the customer-directed reply information d10, in a similar manner to st46. The processing flow then proceeds to st48.

In st48, the customer-directed reply preparing unit 23 judges whether or not the variable i₂ is equal to or greater than a value n_{d} of the number of demands (the number of records) included in the demand information d6. If the variable i₂ is equal to or greater than the value n_{d} (st48; YES), the processing flow proceeds to st50. If the variable i₂ is less than the value n_{d} (st48; NO), the processing flow proceeds to st49.

In st49, the customer-directed reply preparing unit 23 increments the variable i₂ and the processing flow proceeds to st41. In the manner as described above, the customer-directed reply preparing unit 23 repeats the processing from st40 to st49 until it judges that the variable i₂ is equal to or greater than the value n_{d} (st48; YES).

In st50, the customer-directed reply preparing unit 23 prepares the record in the customer-directed reply information d10 for the products P that have not been allocated to the demand in the demand information d6. In one example, for such a record, the customer-directed reply preparing unit 23 sets the customer, the demand status, the desired delivery time, the number of production plan extra days, the number of reply plan extra days, and the customer-directed reply to be undeterminable.

The processing is then ended.

### 1.5.5 Generation of Monthly Summary Information

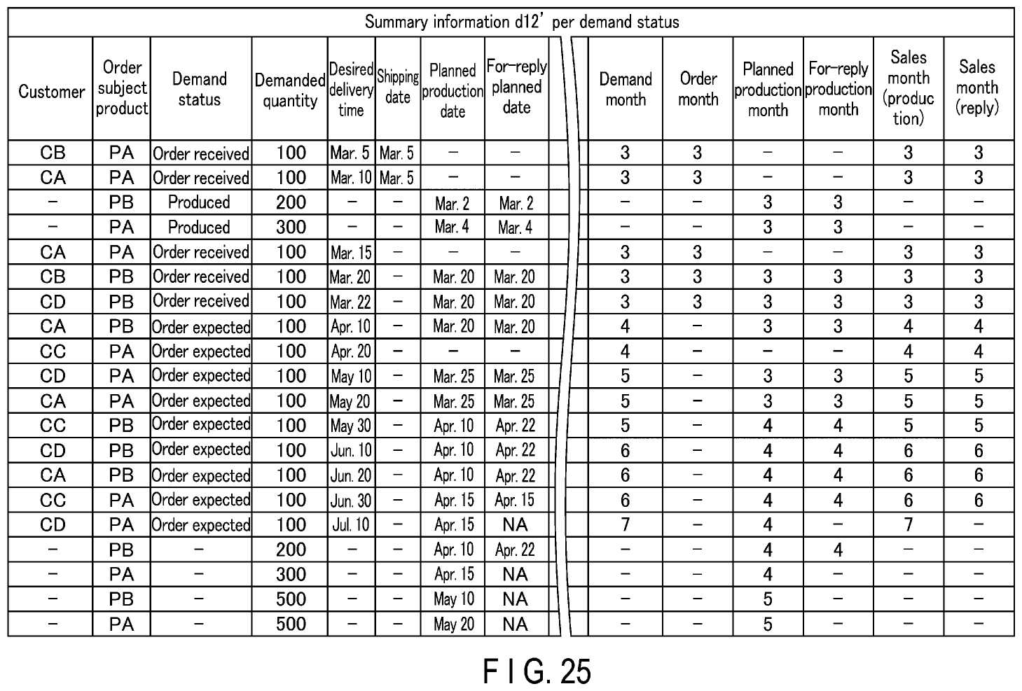

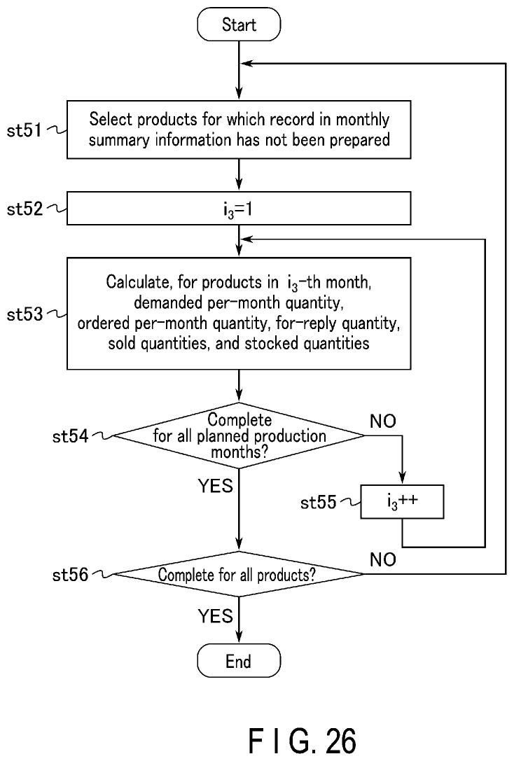

Generation of monthly summary information d12 in st7 will be explained with reference to FIGS. 25 and 26. FIG. 25 shows an example of summary information per demand status generated by the monthly summary preparing unit 25. FIG. 26 is a flowchart for explaining an exemplary generation of the monthly summary information d12 conducted with the planning system 1 according to an embodiment.

In one example, in generating the monthly summary information d12, the monthly summary preparing unit 25 generates summary information d12′ per demand status based on the production result information d4 and the customer-directed reply information d10. In the summary information d12′ per demand status, each combination of data from the record in the customer-directed reply information d10, a demand month, an order month, a planned production month, a for-reply production month, a sales month based on a production plan, and a sales month based on a reply plan is retained. In the example shown in FIG. 25, the sales month based on a production plan and the sales month based on a reply plan are indicated under “Sales month (production)” and “Sales month (reply)”. Note that, in FIG. 25, part of the customer-directed reply information d10 included in the summary information d12′ is omitted.

The monthly summary preparing unit 25 first prepares a record in the summary information d12′ per demand status, for each record in the customer-directed reply information d10. Specifically, the monthly summary preparing unit 25 determines the demand month, the order month, the planned production month, the for-reply production month, the sales month based on a production plan, and the sales month based on a reply plan.

The monthly summary preparing unit 25 sets the month that includes the desired delivery time as the demand month. The monthly summary preparing unit 25 assumes that no desired delivery time is set in the records for products P not allocated for a demand. In FIG. 25, the demand month in each record without a set desired delivery time is shown as “—”.

The monthly summary preparing unit 25 sets, as the order month, the month that includes the desired delivery time in a record with the demand status “Order received”. The monthly summary preparing unit 25 assumes that no fixed order has been received for the record with the demand status “Order expected” and the record without a desired delivery time. In FIG. 25, the order month in each record without a fixed order is shown as “—”.

If the for-reply planned date is a concrete date, the monthly summary preparing unit 25 sets the month that includes this for-reply planned date as the for-reply production month. The monthly summary preparing unit 25 assumes that the for-reply planned date in the record is not set if the for-reply planned date is shown as either “—” or “NA”. In FIG. 25, the for-reply production month in each record without a set for-reply planned date is shown as “—”.

The monthly summary preparing unit 25 sets the sales month based on a production plan to be the month that includes a desired delivery time, in the record in which the demand status is either “Order received” or “Order expected” and the planned production date is on or before the desired delivery date, and also in the record for already shipped products P. The monthly summary preparing unit 25 assumes that no sales month based on a production plan is set in the record with the demand status “—”, and neither in the record with the planned production date later than the desired delivery time. In FIG. 25, the sales month based on a production plan in each record without a set sales month based on a production plan is shown as “—”.

The monthly summary preparing unit 25 sets the sales month based on a reply plan to be the month that includes a desired delivery time, in the record in which the demand status is either “Order received” or “Order expected” and the for-reply planned date is on or before the desired delivery date, and also in the record for already shipped products P. The monthly summary preparing unit 25 assumes that no sales month based on a reply plan is set in the record with the demand status “—” or “Produced”, and neither in the record with the for-reply planned date later than the desired delivery time. In FIG. 25, the sales month based on a reply plan in each record without a set sales month based on a reply plan is shown as “—”.

Next, the monthly summary preparing unit 25 prepares records in the summary information d12′ per demand status, for the already-produced products P in the production result information d4. The monthly summary preparing unit 25 sets the demand status to “Produced”. Also, the monthly summary preparing unit 25 sets the demanded quantity to be the same as the produced quantity. The monthly summary preparing unit 25 sets the planned production date and the for-reply planned date to be the same as the production date. The monthly summary preparing unit 25, in one example, assumes that as this is a case concerning already-produced products P, the customer, the desired delivery time, and the shipping date are not set. Also, while illustration is omitted from the figure, the monthly summary preparing unit 25 sets the production state to conform to the demand status. Further, while illustration is omitted from the figure, as this is a case concerning already-produced products P, the monthly summary preparing unit 25 assumes that the delayed part, the number of production plan extra days, the number of reply plan extra days, and the customer-directed reply are not set.

The monthly summary preparing unit 25 also assumes that, for the already-produced products P in the production result information d4, the demand month, the order month, the sales month based on a production plan, and the sales month based on a reply play are not set. In FIG. 25, they are each shown as “—”. The planned production month and the for-reply production month conform to the record in the summary information d12′ per demand status, prepared for each record in the customer-directed reply information d10.

The monthly summary preparing unit 25 generates the monthly summary information d12 using the summary information d12′ per demand status. Generation of the monthly summary information d12 with the use of the summary information d12′ per demand status will be explained with reference to FIG. 26.

In st51, the monthly summary preparing unit 25 selects products P for which a record in the monthly summary information d12 has not been prepared. The processing flow then proceeds to st52.

In st52, the monthly summary preparing unit 25 initializes a variable i₃ to 1. The processing flow then proceeds to st53.

In st53, the monthly summary preparing unit 25 selects the i₃-th planned production month which is the earliest planned production month from among the planned production months for which records are prepared in the monthly summary information d12. Note that, for example, the planned production months for which records are prepared in the monthly summary information d12 may each be within a predetermined number of months from the month that precedes the planning month. In one example according to an embodiment, six respective records for February to July are prepared for each type of the products P in the monthly summary information d12. Note that the number of the planned production months for which records in the monthly summary information d12 are prepared is not limited to six, and any number of months, for example, two months or more and five months or less, or seven months or more, may be adopted.

The monthly summary preparing unit 25 prepares a record in the monthly summary information d12 for the selected planned production month. That is, the monthly summary preparing unit 25 calculates a demanded per-month quantity, an ordered per-month quantity, a for-reply quantity, a sold quantity based on a production plan, a sold quantity based on a reply plan, a stocked quantity based on the production plan, and a stocked quantity based on the reply plan.

The monthly summary preparing unit 25 sets, as the demanded per-month quantity, the sum of the demanded quantities in the records that are included in the summary information d12′ per demand status and are with the demand month conforming to the planned production month selected above.

Also, the monthly summary preparing unit 25 sets, as the ordered per-month quantity, the sum of the demanded quantities in the records that are included in the summary information d12′ per demand status and are with the demand status “Order received” and the demand month conforming to the planned production month selected above.

The monthly summary preparing unit 25 sets, as the for-reply quantity, the sum of the demanded quantities in the records that are included in the summary information d12′ per demand status and indicate a for-reply planned date within the planned production month.

The monthly summary preparing unit 25 sets, as the sold quantity based on a production plan, the sum of the demanded quantities in the records that are included in the summary information d12′ per demand status, indicate a desired delivery time within the planned production month, and are with the number of production plan extra days shown as “—”, “—(In stock)”, or as a positive number.

Also, the monthly summary preparing unit 25 sets, as the sold quantity based on a reply plan, the sum of the demanded quantities in the records that are included in the summary information d12′ per demand status, indicate a desired delivery time within the planned production month, and are with the number of reply plan extra days shown as “—”, “—(In stock)”, or as a positive number.

The monthly summary preparing unit 25 sets, as the stocked quantity based on the production plan, the quantity obtained by subtracting the sold quantity based on the production plan for the planned production month from the sum of the stocked quantity based on the production plan for the month preceding the planned production month and the planned per-month quantity for the planned production month.

Also, the monthly summary preparing unit 25 sets, as the stocked quantity based on the reply plan, the quantity obtained by subtracting the sold quantity based on the reply plan for the planned production month from the sum of the stocked quantity based on the reply plan for the month preceding the planned production month and the planned per-month quantity for the planned production month.

The monthly summary preparing unit 25 sets the planned per-month quantity and the flag in the monthly summary information d12 to conform to the planned per-month quantity and the flag appearing in the production plan guide information d5 for the planned production month. Here, the monthly summary preparing unit 25 assumes that the planned per-month quantity and the flag are not set for the planned production month not included in the production plan guide information d5.

The processing flow then proceeds to st54.

In st54, the monthly summary preparing unit 25 judges whether or not records in the monthly summary information d12 have been prepared for a predetermined number of planned production months. If it is judged that records in the monthly summary information d12 have been prepared for the predetermined number of planned production months (st54; YES), the processing flow proceeds to st56. If it is judged that there is a planned production month for which a record in the monthly summary information d12 has not been prepared (st54; NO), the processing flow proceeds to st55.

In st55, the monthly summary preparing unit 25 increments the variable i₃ and the processing flow proceeds to st53.

In st56, the monthly summary preparing unit 25 judges whether or not records in the monthly summary information d12 have been prepared for all the products P. If it is judged that records in the monthly summary information d12 have been prepared for the all the products P (st56; YES), the processing is ended. If it is judged that there is a product P for which a record in the monthly summary information d12 has not been prepared (st56; NO), the processing flow proceeds to st51. In the manner as described above, the monthly summary preparing unit 25 repeats the processing from st51 to st56 until it judges that records in the monthly summary information d12 have been prepared for the all the products P (st56; YES).

The processing is thus ended.

### 2 Effects

According to the embodiments, it is possible to suppress amplified fluctuations in demand for parts M of products P.

In the planning system according to an embodiment, the allocating unit 21 performs an allocation process of allocating, for each of production operations of producing products P planned to be conducted on multiple planned production dates, at least one of multiple allocation materials which include one or more parts M and one or more work-in-progress items WIP. In the allocation process, the allocating unit 21 calculates, for each of the production operations of producing the products P for which one or more parts M are allocated, a request date representing a schedule to consume such one or more parts M. With this configuration, the planning system 1 according to the embodiment can give an order for the parts M to the supplier X based on the request date for the parts calculated through the allocation process. That is, the part request preparing unit 24 can generate the part request information d11 using the allocation information d8. This can improve the accuracy in estimating the quantities of parts M to be ordered to the supplier X and can consequently suppress the amplified demand fluctuations which would otherwise be caused by the bullwhip phenomenon.

To be more specific, it has been difficult to prevent a decrease in estimating accuracy for ordered quantities of parts in instances where a so-called “reply system” for the production of products and a so-called “request system” for the request for parts are separate from each other. The reply system, for example, generates a plan (a short-term production plan) for conducting production of products based on quantities of parts and work-in-progress items in inventory, for the production of products over the short term (e.g., in last one month, etc.). The request system, for example, gives orders for parts based on a plan (a medium to long-term production plan) for the production of products over the medium to long term. In such a reply system and a request system, the short-term production plan and the medium to long-term production plan are not directly associated with each other. As such, it has been difficult to take into account the conditions and statuses of parts, such as results of allocating parts for the production of products, in the instances of making orders for parts for use in the production of products over the medium to long term. This has created conditions in which preventing a decrease in estimating accuracy for ordered quantities of parts is rendered difficult.

According to the embodiments, the allocating unit 21 realizes an order for the parts M based on the result of the allocation process utilizing the production plan which covers the short-term production of products P and the medium to long-term production of products P. Therefore, the embodiments allow orders for parts M to be made based on the state of allocation of the parts M for the production of products P, irrespective of terms. This achieves improved accuracy in estimating the ordered quantities of parts M.

### 3 Others

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A planning system comprising
an allocating unit configured to perform an allocation process of allocating, for each of production operations of producing products planned to be conducted on multiple planned production dates, at least one of multiple allocation materials which comprise one or more parts and one or more work-in-progress items,
wherein, in the allocation process, the allocating unit calculates, for each of the production operations of producing the products for which the one or more parts are allocated, an expected consumption date representing a schedule to consume the allocated one or more parts.

2. The planning system according to claim 1, wherein the one or more parts are in one of arrival states comprising a state in which the one or more parts are in inventory, a state in which the one or more parts are expected to arrive, and a state in which an order for the one or more parts are to be made.

3. The planning system according to claim 1, further comprising a first reply preparing unit configured to calculate, based on a result of the allocation process, multiple for-reply planned dates on which the production operations of producing the products planned for the multiple planned production dates are conducted,
wherein
the allocating unit calculates, in the allocation process, multiple reply-possible production dates representing dates on which the production operations of producing the products respectively with the allocated allocation materials are assumed to be possible, and
the first reply preparing unit determines the multiple for-reply planned dates based on the multiple planned production dates and the multiple reply-possible production dates.

4. The planning system according to claim 3, further comprising a production planning unit configured to plan the production operations of producing the products for the multiple planned production dates based on production plan guide information comprising a target value of a produced quantity of the products for each term.

5. The planning system according to claim 4, further comprising a summary preparing unit configured to generate summary information comprising a sold quantity and a stocked quantity for the each term based on the multiple planned production dates and the multiple for-reply planned dates,
wherein the summary information is fed back to new production plan guide information.

6. The planning system according to claim 5, wherein the production planning unit is configured to plan, based on the new production plan guide information, production operations of producing the products for multiple new planned production dates.

7. The planning system according to claim 3, wherein the first reply preparing unit is configured to calculate the multiple for-reply planned dates based on demand information on a received order for the products and an expected order for the products, in addition to based on the result of the allocation process.

8. The planning system according to claim 7, further comprising a second reply preparing unit configured to calculate the product delivery time using the multiple for-reply planned dates and the demand information.

9. The planning system according to claim 1, further comprising a part request preparing unit configured to extract information on the one or more parts allocated for production operations of producing the products.

10. A planning method comprising:
allocating, for each of production operations of producing products planned to be conducted on multiple planned production dates, at least one of multiple allocation materials which comprise one or more parts and one or more work-in-progress items; and
calculating, for each of the production operations of producing the products for which the one or more parts are allocated, an expected consumption date representing a schedule to consume the allocated one or more parts.

11. A planning program for causing a computer to:
allocate, for each of production operations of producing products planned to be conducted on multiple planned production dates, at least one of multiple allocation materials which comprise one or more parts and one or more work-in-progress items; and
calculate, for each of the production operations of producing the products for which the one or more parts are allocated, an expected consumption date representing a schedule to consume the allocated one or more parts.
